(19) United States
(12) Patent Application Publication
(10) Pub. No.: US 2026/0363516 A1
(43) Pub. Date: Nov. 19, 2026

(54) CLEANER

(71) Applicant: SAMSUNG ELECTRONICS CO., LTD., Suwon-si (KR)

(72) Inventors: Byoungin LEE, Suwon-si (KR); Ahreum HAN, Suwon-si (KR)

(73) Assignee: SAMSUNG ELECTRONICS CO., LTD., Suwon-si (KR)

(21) Appl. No.: 19/556,664

(22) Filed: Mar. 4, 2026

Related U.S. Application Data
(63) Continuation of application No. PCT/KR2026/002725, filed on Feb. 13, 2026.

(30) Foreign Application Priority Data
May 13, 2025 (KR) 10-2025-0062222

(51) Int. Cl. A47L 11/40; F16H 37/12

(52) U.S. Cl. CPC A47L 11/4069; A47L 11/4011; A47L 11/4038; F16H 37/122

(57) ABSTRACT

A cleaner may include a housing, a cleaning pad movable to a first and a second position, and spaced farther from a center of the housing in the second position than in the first position, and a pad moving device for moving the cleaning pad and including a drive source, a lever gear configured to receive power from the drive source and rotate the drive source, a guide gear configured to rotate the lever gear based on rotation of the lever gear, a guide lever that is rotatable relative the guide gear and configured to rotate the lever gear based on rotation of the guide gear, and an elastic member elastically deformable and configured to rotate the guide lever relative the guide gear and such that, with an obstacle moving the cleaning pad from the second position, the elastic member forces the cleaning pad toward the second position.

### CROSS-REFERENCE TO RELATED APPLICATIONS

This is a continuation application, under 35 U.S.C. §111(a), of International Application No. PCT/KR2026/002725, filed Feb. 13, 2026, which claims priority under 35 U.S.C. §119 to Korean Patent Application No. 10-2025-0062222, filed May 13, 2025, in the Korean Intellectual Property Office, the disclosures of which are incorporated herein in their entireties by reference.

### TECHNICAL FIELD

The disclosure relates to a cleaner including a cleaning pad.

### Background Art

A cleaner is a device that cleans an indoor space by removing foreign matter. The cleaner cleans the indoor space by drawing in air using the suction power of a suction motor and then separating foreign matter in the suctioned air with a device, such as a filter.

A robot cleaner, as an example of a cleaner, is a device that automatically cleans a cleaning space by moving through the cleaning space and suctioning foreign matter such as dust accumulated on the floor without user intervention. A robot cleaner travels through the cleaning space to clean the same space.

The robot cleaner determines a distance to obstacles such as furniture, office equipment, walls, and the like, installed in a cleaning area through a distance sensor, and cleans the cleaning area by autonomously changing its direction by selectively driving a left drive device and a right drive device of the robot cleaner.

The robot cleaner may not only suction foreign matter, such as dirt, from the floor but may also wipe the dirt off the floor. For example, the robot cleaner may clean the floor via a dust collection device, or may clean the floor via a cleaning pad equipped with a wet cloth and/or a dry cloth.

### Disclosure

### Technical Problem

An embodiment of the present disclosure provides a cleaner with improved movement performance of a cleaning pad.

An embodiment of the present disclosure provides a cleaner in which a cleaning pad may stably perform cleaning.

Technical tasks to be achieved in this document are not limited to the technical tasks mentioned above, and other technical tasks not mentioned will be clearly understood by those skilled in the art from the description below.

### Technical Solution

In accordance with the present disclosure a cleaner may include: a housing; a cleaning pad movable to a first position and a second position, the cleaning pad spaced farther from a center of the housing in the second position than in the first position; and a pad moving device to move the cleaning pad, the pad moving device including: a moving drive source configured to generate power, a lever gear configured to receive the power generated by the moving drive source and rotate relative to the moving drive source based on the received power, a guide gear configured to rotate relative to the lever gear based on rotation of the lever gear, a guide lever that is rotatable relative to the guide gear and configured to rotate relative to the lever fear based on rotation of the guide gear, and an elastic member that is elastically deformable and configured to rotate the guide lever relative to the guide gear, wherein the elastic member is configured such that, with an obstacle causing the cleaning pad to move from the second position, the elastic member provides a force to move the cleaning pad toward the second position.

The cleaner may further include: a pad rotating device on which the cleaning pad may be mounted, the pad rotating device may be configured to rotate the cleaning pad, wherein the guide lever may be coupled to the pad rotating device.

The pad rotating device may include: a first portion to which the guide lever may be coupled, the first portion may be rotatable about a rotation axis of the guide lever based on rotation of the guide lever, and a second portion on which the cleaning pad may be mounted, the second portion may be configured to move based on rotation of the first portion.

A rotation axis of the first portion of the pad rotating device and the rotation axis of the guide lever may be coaxial.

A rotation axis of the first portion of the pad rotating device may be parallel to a rotation axis of the lever gear.

With the cleaning pad in the second position, based on a force applied to the cleaning pad to move the cleaning pad in a direction toward the first position, the guide lever may be configured to rotate to move the cleaning pad to a third position between the first position and the second position.

With the guide lever rotated to move the cleaning pad to the third position, the elastic member may apply a force to the guide lever in a direction in which the guide lever moves the cleaning pad to the second position.

The elastic member may include: a first end fixed to the guide gear, and a second end fixed to the guide lever and opposite to the first end.

The guide gear may include an elastic member receiving portion in which the elastic member may be received, and the guide lever may include a core support portion that may be supported by the elastic member received in the elastic member receiving portion.

The guide lever may include an elastic member receiving portion in which the elastic member may be received, and the guide gear may include a guide support portion that may be supported by the elastic member received in the elastic member receiving portion.

The cleaner may further include: a guide cover that covers at least a portion of the pad moving device, the guide cover may include a lever stopper that may be configured to limit a rotation range of the lever gear.

The cleaner may further include: a position sensor configured to detect a position of the cleaning pad; and a controller configured to: stop an operation of the moving drive source based on the detected position of the cleaning pad indicating the cleaning pad is in the second position, and operate the moving drive source based on the detected position of the cleaning pad indicating the cleaning pad is moved from the second position.

The lever gear may include lever gear teeth and a gear support portion having a shape that may be different from a shape of the lever gear teeth, and with the cleaning pad in the first position and being rotated by a pad rotating device, in order to prevent the cleaning pad from moving to the second position, the lever gear may be rotatable to a support position in which the gear support portion may engage the guide gear.

The gear support portion may be larger than a tooth of the lever gear teeth, and the guide gear may include a gear receiving portion that may be configured to receive the gear support portion.

The elastic member may include a compression spring or a torsion spring.

The lever gear and guide gear may be configured to rotate in opposite directions.

A cleaner according to an embodiment of the present disclosure includes a housing, a cleaning pad movable to a first position and a second position spaced farther from a center of the housing than the first position, a pad moving device configured to move the cleaning pad, and a pad rotating device configured to mount the cleaning pad thereon is mounted and to rotate the cleaning pad. The pad moving device includes a moving drive source, a lever gear rotatable by power received from the moving drive source, a guide gear rotatable based on rotation of the lever gear, a guide lever rotatable relative to the guide gear and coupled to the pad rotating device, and an elastic member including a first end fixed to the guide gear and a second end fixed to the guide lever.

### DESCRIPTION OF DRAWINGS

FIG. 1 illustrates a cleaner according to an embodiment of the present disclosure from the front.

FIG. 2 illustrates the cleaner according to an embodiment of the present disclosure from the rear.

FIG. 3 illustrates a bottom portion of the cleaner according to an embodiment of the present disclosure.

FIG. 4 illustrates configurations for driving a cleaning pad of the cleaner according to an embodiment of the present disclosure.

FIG. 5 illustrates a pad rotating device and a pad moving device for driving the cleaning pad of the cleaner according to an embodiment of the present disclosure.

FIG. 6 is an exploded upper perspective view of the pad moving device of the cleaner according to an embodiment of the present disclosure.

FIG. 7 is an exploded lower perspective view of the pad moving device of the cleaner according to an embodiment of the present disclosure.

FIG. 8 illustrates a state in which a pad moving device and a pad rotating device are covered by a guide cover when the cleaning pad of the cleaner is in a first position, according to an embodiment of the present disclosure.

FIG. 9 illustrates a state of the pad moving device and the pad rotating device when the cleaning pad of the cleaner is in the first position, according to an embodiment of the present disclosure.

FIG. 10 illustrates a state in which the pad moving device and the pad rotating device are covered by the guide cover when the cleaning pad of the cleaner is in a second position, according to an embodiment of the present disclosure.

FIG. 11 illustrates a state of the pad moving device and the pad rotating device when the cleaning pad of the cleaner is in the second position, according to an embodiment of the present disclosure.

FIG. 12 illustrates a state in which the pad moving device and the pad rotating device are covered by the guide cover when the cleaning pad is in a third position as a force of a first magnitude is applied to the cleaning pad of the cleaner according to an embodiment of the present disclosure.

FIG. 13 illustrates a state of the pad moving device and the pad rotating device when the cleaning pad is in the third position as the force of the first magnitude is applied to the cleaning pad of the cleaner according to an embodiment of the present disclosure.

FIG. 14 illustrates a state in which the pad moving device and the pad rotating device are covered by the guide cover when the cleaning pad is in the third position as a force of a second magnitude is applied to the cleaning pad of the cleaner according to an embodiment of the present disclosure.

FIG. 15 illustrates a state of the pad moving device and the pad rotating device when the cleaning pad is in the third position as the force of the second magnitude is applied to the cleaning pad of the cleaner according to an embodiment of the present disclosure.

FIG. 16 illustrates a state in which the pad moving device and the pad rotating device are covered by the guide cover when a lever gear is in a support position while the cleaning pad of the cleaner is in the first position, according to an embodiment of the present disclosure.

FIG. 17 illustrates a state of the pad moving device and the pad rotating device when the lever gear is in the support position while the cleaning pad of the cleaner is in the first position, according to an embodiment of the present disclosure.

FIG. 18 is an exploded upper perspective view of a pad moving device of a cleaner according to an embodiment of the present disclosure.

FIG. 19 is an exploded lower perspective view of the pad moving device of the cleaner according to an embodiment of the present disclosure.

FIG. 20 illustrates a pad rotating device and a pad moving device for driving a cleaning pad of a cleaner according to an embodiment of the present disclosure.

FIG. 21 is an exploded upper perspective view of a pad moving device of a cleaner according to an embodiment of the present disclosure.

FIG. 22 is an exploded lower perspective view of the pad moving device of the cleaner according to an embodiment of the present disclosure.

FIG. 23 is an exploded upper perspective view of a pad moving device of a cleaner according to an embodiment of the present disclosure.

FIG. 24 is an exploded lower perspective view of the pad moving device of the cleaner according to an embodiment of the present disclosure.

FIG. 25 is a control block diagram of a cleaner according to an embodiment of the present disclosure.

### DETAILED DESCRIPTION OF THE EMBODIMENTS

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a”, “an” and “the” are intended to include the plural forms as well, unless the context clearly indicates otherwise.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

The term of “and/or” includes a plurality of combinations of relevant items or any one item among a plurality of relevant items.

It will be understood that, although the terms “1st”, “2nd”, “primary”, “secondary”, etc., may be used simply to distinguish a component from other applicable components and do not qualify such components in any other respect (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, configurations, components, members, or combinations thereof, but do not preclude the presence or addition of one or more other features, figures, steps, operations, configurations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Hereinafter, for ease of description, a robot cleaner (also referred to as a robot vacuum cleaner), which is a type of cleaner, will be described as an example, but a configuration of the present disclosure is not limited to a robot cleaner. For example, the configuration of the present disclosure may also be applied to a canister-type cleaner or a stick-type cleaner, and the like.

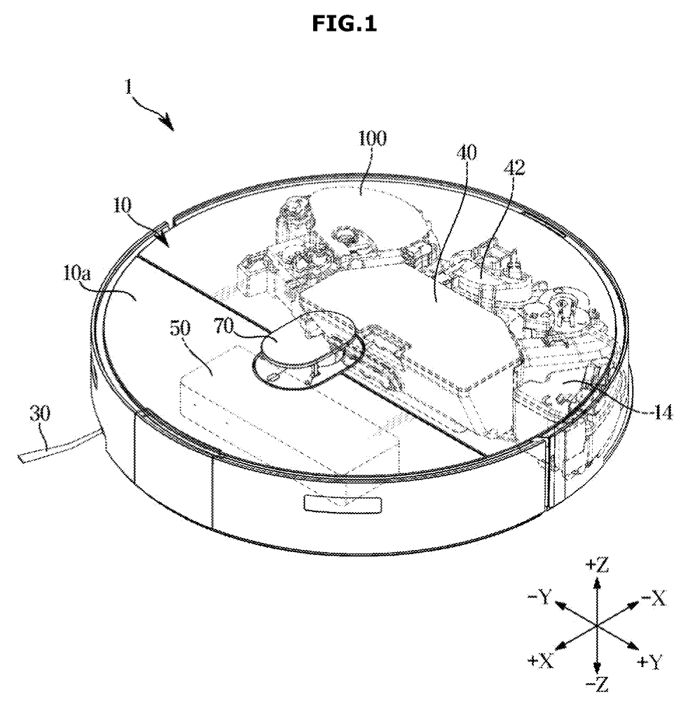

Meanwhile, in the following description, the terms “front”, “rear”, “left”, “right”, “upper”, “lower”, and the like are defined based on the drawings, and the shape and position of each component are not limited by these terms. For example, as shown in FIGS. 1-3, a direction in which a cleaning pad 101 is positioned from the center of a cleaner 1 may be defined as a rear (-X direction), and the opposite direction may be defined as a front (+X direction).

Hereinafter, various embodiments will be described in detail with reference to the accompanying drawings.

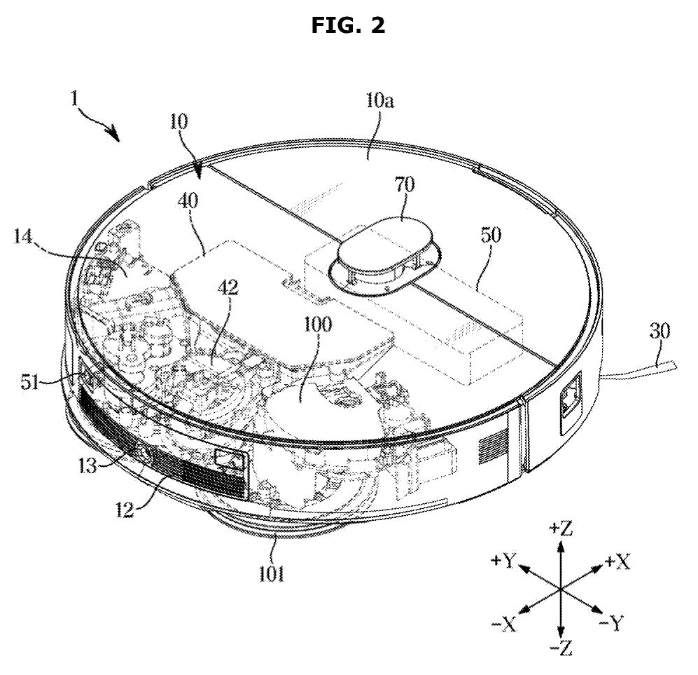

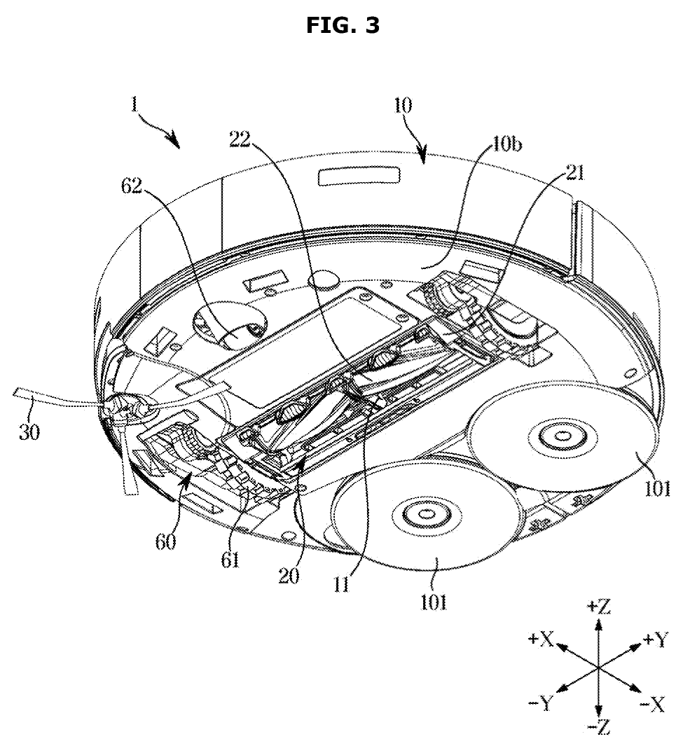

FIG. 1 illustrates a cleaner according to an embodiment of the present disclosure from the front. FIG. 2 illustrates the cleaner according to an embodiment of the present disclosure from the rear. FIG. 3 illustrates a bottom portion of the cleaner according to an embodiment of the present disclosure.

Referring to FIGS. 1-3, the cleaner 1 may include a housing 10. The housing 10 may form the overall exterior of the cleaner 1. Components of the cleaner 1 may be accommodated inside the housing 10. For example, electronic components may be disposed inside the housing 10.

The cleaner 1 may include an intake inlet 11. The intake inlet 11 may be formed to face a surface to be cleaned. The intake inlet 11 may be open toward the surface to be cleaned. In an example, the intake inlet 11 may be formed in the housing 10. The intake inlet 11 may be formed in a lower portion of the housing 10. The intake inlet 11 may be formed through a lower housing 10b of the housing 10. Dirt on the surface to be cleaned may be drawn into the housing 10 through the intake inlet 11 along with air.

In an example, the cleaner 1 may include a brush 30. The brush 30 may strike the surface to be cleaned to scatter dirt. The dirt scattered by the brush 30 may enter the intake inlet 11 with air.

For example, the cleaner 1 may include the brush 30 disposed adjacent to a lower edge of the housing 10. The brush 30 may guide dirt around the housing 10 to the intake inlet 11. The brush 30 may be rotatably mounted to the housing 10. A rotation axis of the brush 30 may be an axis extending in a substantially vertical direction (Z-direction). The brush 30 may be referred to as a side brush 30.

The cleaner 1 may include a dust collector 40. Dirt and/or air drawn into through the intake inlet 11 may be directed to the dust collector 40. Dirt drawn into through the intake inlet 11 may be collected in the dust collector 40. Air drawn into through the intake inlet 11 may be filtered as it passes through the dust collector 40. Dirt and air drawn into through the intake inlet 11 may be separated in the dust collector 40.

The cleaner 10 may include an exhaust outlet 12. The exhaust outlet 12 may be formed in the housing 10. The exhaust outlet 12 may be formed on a rear side of the housing 10. Air drawn into through the intake inlet 11 may be filtered and discharged to an outside of the cleaner 1 through the exhaust outlet 12. For example, the exhaust outlet 12 may be provided in a plurality, and the plurality of exhaust outlets 12 may be configured as a plurality of holes.

The cleaner 1 may include an intake motor 42. The intake motor 42 may generate an intake force. By the intake force generated by the intake motor 42, the intake inlet 11 may draw in dirt and/or air. By the intake force generated by the intake motor 42, the exhaust outlet 12 may discharge the filtered air, which was drawn into the cleaner 1, to the outside. The intake motor 42 may be disposed in an air flow path formed between the intake inlet 11 and the exhaust outlet 12.

The cleaner 1 may include a drum module 20 disposed at the intake inlet 11. The drum module 20 may scatter dirt by striking the surface to be cleaned. The dirt scattered by the drum module 20 may be drawn into the intake inlet 11 with air. In an example, the drum module 20 may include a drum case 21 and a drum 22 rotatably mounted to the drum case 21.

The cleaner 1 may include a battery 50. The battery 50 may be provided to be rechargeable. The battery 50 may provide power to drive the cleaner 1.

The cleaner 1 may include a charging terminal 51. The charging terminal 51 may be electrically connected to the battery 50. For example, while the cleaner 1 is docked at a station, the charging terminal 51 of the cleaner 1 may be electrically connected to a charging terminal of the station. As the charging terminal 51 of the cleaner 1 is electrically connected to the charging terminal of the station, the battery 50 of the cleaner 1 may be charged. In other words, while the cleaner 1 is docked at the station, the battery 50 may be charged.

The cleaner 1 may include a driving device 60 for traveling of the cleaner 1. The driving device 60 may be mounted to the housing 10 to move the housing 10. For example, the driving device 60 may include a pair of driving wheels 61. For example, the driving device 60 may further include at least one caster 62 for stable traveling of the cleaner 1.

The driving device 60 may be configured to move the housing 10. In an example, the driving device 60 may be provided on a left side and a right side of the housing 10, respectively. By selectively actuating the driving devices 60 provided on the left and right sides of the housing 10, the cleaner 1 may be moved forward, backward, leftward, or rightward.

The cleaner 1 may include a cleaning pad 101. The cleaning pad 101 may be detachably mountable to the lower portion of the housing 10. The cleaning pad 101 may be rotatably mounted relative to the housing 10. The cleaning pad 101 may be movable relative to the housing 10 to a first position and a second position, which is spaced farther from a center of the housing 10 than the first position.

The cleaning pad 101 may be configured to contact the surface to be cleaned and to clean the surface to be cleaned. The cleaning pad 101 may wipe away dirt from the surface to be cleaned in a wet state. While two cleaning pads 101 are shown in the drawings, the number of cleaning pads 101 is not limited thereto. In an example, the cleaning pad 101 may include a wet pad. For example, the cleaning pad 101 may include a wet mop.

The cleaning pad 101 may be supplied with moisture from a water tank 14 of the cleaner 1. For example, when the water content of the cleaning pad 101 becomes low during cleaning by the cleaner 1, water stored in the water tank 14 may be fed to the cleaning pad 101.

The cleaner 1 may include a water filling portion 13. The water filling portion 13 may be formed in the housing 10. The water filling portion 13 may be formed on a rear side of the housing 10. For example, while the cleaner 1 is docked at the station, the water filling portion 13 may receive water supplied from the station. The water supplied to the cleaner 1 through the water filling portion 13 may be stored in the water tank 14. While the cleaner 1 is docked at the station, the water filling portion 13 of the cleaner 1 may be docked with a water supply portion of the station.

The cleaner 1 may include an obstacle sensor 70. In an example, the obstacle sensor 70 may be configured to detect a location of an obstacle or a distance from an obstacle. The obstacle sensor 70 may be mounted to the housing 10. For example, the obstacle sensor 70 may protrude from an upper housing 10a of the housing 10.

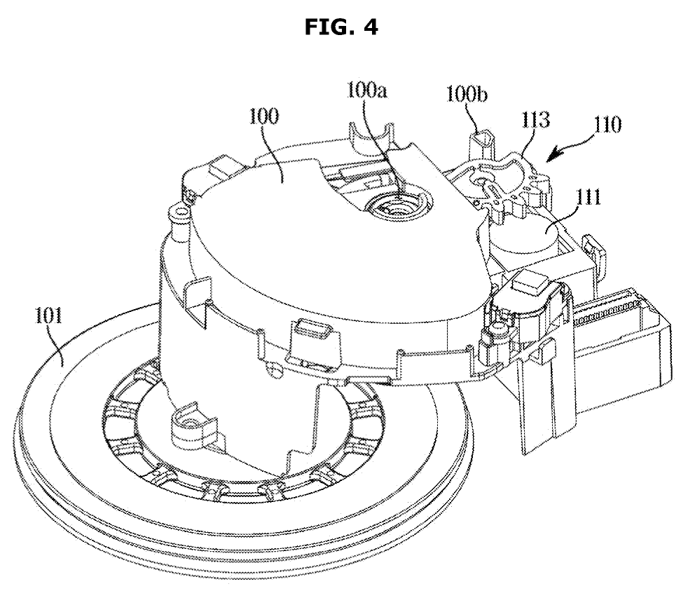

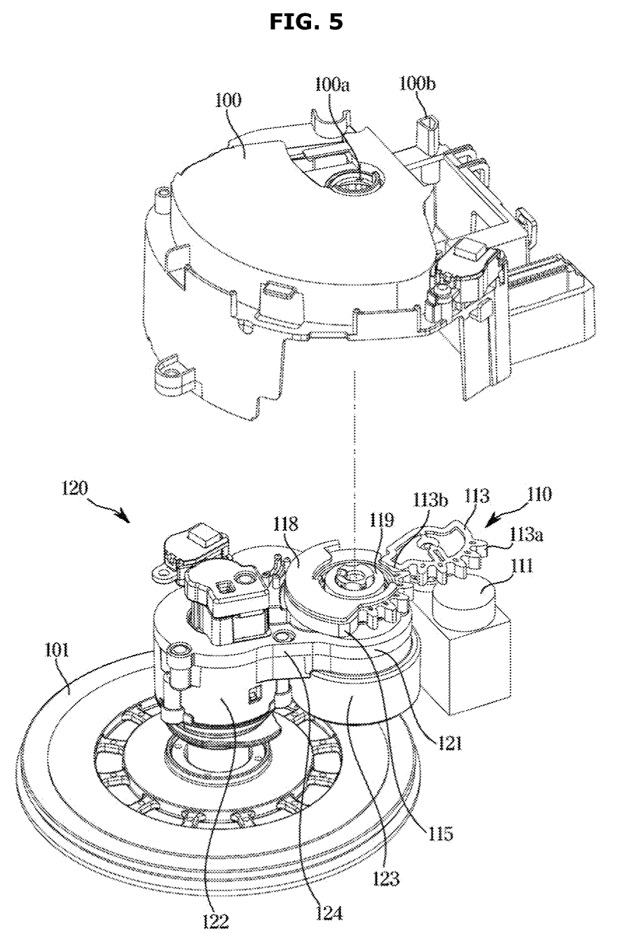

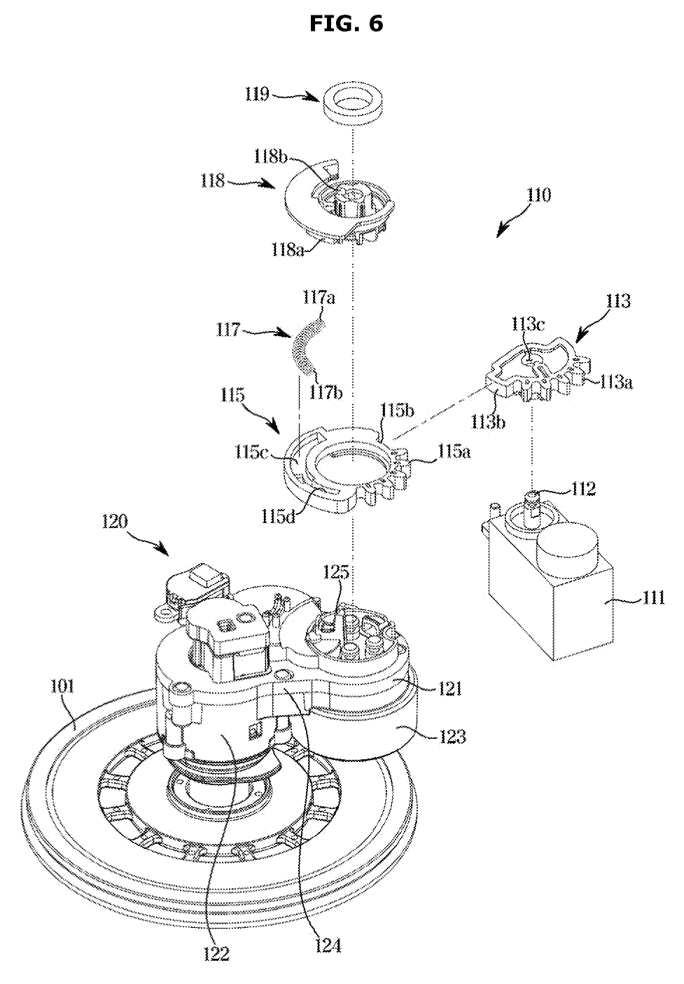

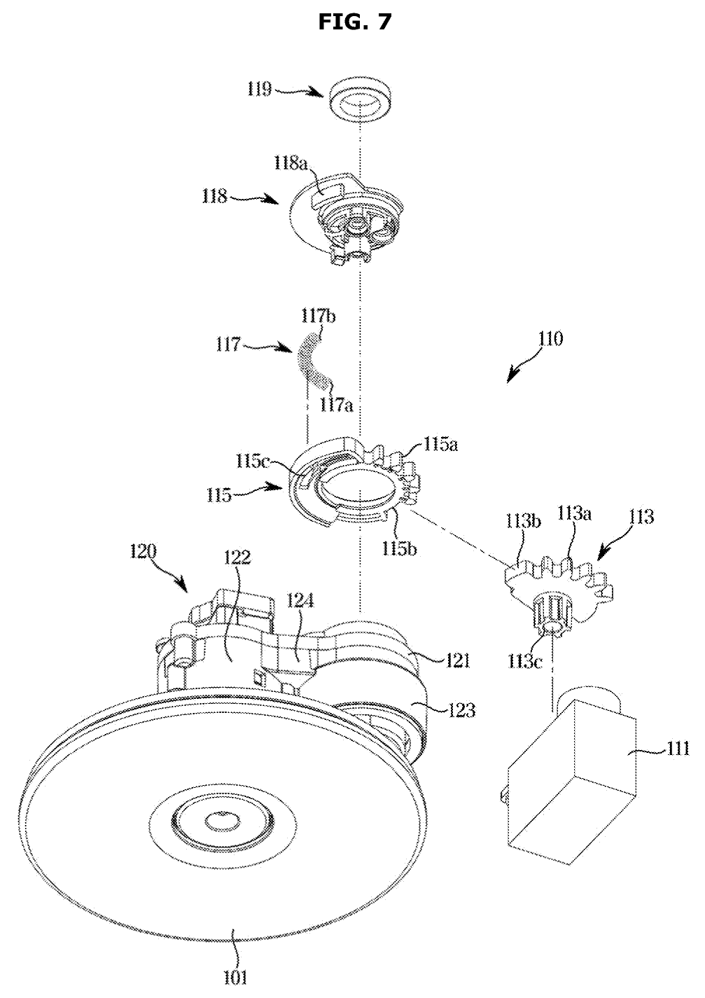

FIG. 4 illustrates configurations for driving a cleaning pad of the cleaner according to an embodiment of the present disclosure. FIG. 5 illustrates a pad rotating device and a pad moving device for driving the cleaning pad of the cleaner according to an embodiment of the present disclosure. FIG. 6 is an exploded upper perspective view of the pad moving device of the cleaner according to an embodiment of the present disclosure. FIG. 7 is an exploded lower perspective view of the pad moving device of the cleaner according to an embodiment of the present disclosure.

Referring to FIGS. 4 and 5, the cleaner 1 according to an embodiment of the present disclosure may include a guide cover 100 configured to cover at least a portion of a pad moving device 110 and/or a pad rotating device 120. In an example, the guide cover 100 may be mounted on an interior of the housing 10.

In an example, the guide cover 100 may include a wire opening 100a through which electric wires extending from the pad moving device 110 and/or the pad rotating device 120 may pass. For example, the wire opening 100a for the electric wires extending from the pad moving device 110 and/or the pad rotating device 120 may be open toward an upper side.

In an example, the guide cover 100 may include a lever stopper 100b for limiting a rotation range of a lever gear 113 of the pad moving device 110. The lever stopper 100b may be arranged to be positioned within the rotation range of the lever gear 113. The lever stopper 110b may be configured to interfere with rotation of the lever gear 113. For example, a rotation axis of the lever gear 113 may be oriented in an up-and-down direction, and the lever stopper 100b may extend in the up-and-down direction. The lever stopper 100b may limit a rotation range for moving the cleaning pad 101 to a first position and/or a rotation range for moving the cleaning pad 101 to a second position of the lever gear 113.

The cleaner 1 according to an embodiment of the present disclosure may include the pad rotating device 120 configured to rotate the cleaning pad 101. The cleaning pad 101 may be detachably mounted to the pad rotating device 120. The pad rotating device 120 may be configured to rotate the cleaning pad 101 to wipe away dirt from the surface to be cleaned.

The pad rotating device 120 may include a rotary drive source 123. The rotary drive source 123 may be configured to generate power for rotation of the cleaning pad 101. In an example, the rotary drive source 123 may include a motor and a motor case covering the motor.

The pad rotating device 120 may include a power transmission portion 124 configured to transmit the power generated by the rotary drive source 123 to the cleaning pad 101. In an example, the power transmission portion 124 may include a plurality of gears and a case in which the plurality of gears are accommodated. As the power generated by the rotary drive source 123 is transmitted to the cleaning pad 101 via the power transmission portion 124, the cleaning pad 101 may rotate relative to the housing 10 and wipe away dirt from the surface to be cleaned.

The pad rotating device 120 may include a first portion 121 that rotates during operation of the pad moving device 110. The first portion 121 of the pad rotating device 120 may be connected to the pad moving device 110. The first portion 121 of the pad rotating device 120 may be coupled to a guide lever 118 of the pad moving device 110. The first portion 121 of the pad rotating device 120 may rotate about a rotation axis of the guide lever 118 based on the rotation of the guide lever 118. In an example, the rotary drive source 123 of the pad rotating device 120 may be positioned in the first portion 121 of the pad rotating device 120.

In an example, the rotation axis of the first portion 121 of the pad rotating device 120 may be arranged to be the same as the rotation axis of the guide lever 118. In an example, the rotation axis of the first portion 121 of the pad rotating device 120 may be arranged to be parallel to the rotation axis of the guide lever 118. In an example, the rotation axis of the first portion 121 of the pad rotating device 120 may be arranged to be parallel to the rotation axis of the lever gear 113.

The pad rotating device 120 may include a second portion 122 that moves during operation of the pad moving device 110. The second portion 122 of the pad rotating device 120 may move based on the rotation of the first portion 121 of the pad rotating device 120. The second portion 122 of the pad rotating device 120 may be connected to the cleaning pad 101. Based on the first portion 121 of the pad rotating device 120 being rotated by the pad moving device 110, the cleaning pad 101 mounted on the second portion 122 of the pad rotating device 120 may be moved.

Referring to FIGS. 5-7, the cleaner 1 according to an embodiment of the present disclosure may include the pad moving device 110 configured to move the cleaning pad 101. Based on operation of the pad moving device 110, the cleaning pad 101 may be moved relative to the housing 10 to a first position and a second position, which is spaced farther from the center of the housing 10 than the first position. Based on operation of the pad moving device 110, the cleaning pad 101 may move to the first position, which is closer to the center of the housing 10 than the second position.

The pad moving device 110 may include a moving drive source 111. The moving drive source 111 may be configured to generate power to move the cleaning pad 101. For example, the moving drive source 111 may include a motor. In an example, the moving drive source 111 may be mounted to the guide cover 100.

The pad moving device 110 may include the lever gear 113. The lever gear 113 may be rotatably provided to receive power from the moving drive source 111. The lever gear 113 may be connected to an axle shaft 112 of the moving drive source 111. As the moving drive source 111 operates, the axle shaft 112 rotates, and as the axle shaft 112 rotates, the lever gear 113 connected to the axle shaft 112 rotates. The lever gear 113 may include a shaft insertion portion 113c into which the axle shaft 112 of the moving drive source 111 is inserted.

The lever gear 113 may include a lever gear tooth 113a. The lever gear tooth 113a may be provided on at least a portion along a circumference of the lever gear 113. In an example, the lever gear tooth 113a may include a plurality of gear teeth. The lever gear teeth 113a may be arranged to engage with guide gear teeth 115a of a guide gear 115. The lever gear teeth 113a may be provided to correspond to the guide gear teeth 115a.

The lever gear 113 may include a gear support portion 113b having a shape different from the lever gear teeth 113a. In an example, the gear support portion 113b may have a larger size than the lever gear teeth 113a. For example, the gear support portion 113b may have a shape connecting two of the plurality of lever gear teeth 113a. The gear support portion 113b may support the guide gear 115 in order to prevent the guide gear 115 from rotating to move the cleaning pad 101 to the second position when the cleaning pad 101 is in the first position.

The pad moving device 110 may include the guide gear 115. The guide gear 115 may be provided to be rotatable based on rotation of the lever gear 113. The guide gear 115 may be configured to engage with the lever gear 113. The guide gear 115 may be provided to be rotatable relative to the pad rotating device 120. The guide gear 115 may be rotatably supported on the pad rotating device 120. The guide gear 115 may be provided to be rotatable relative to the guide lever 118.

The guide gear 115 may include guide gear teeth 115a. The guide gear teeth 115a may be provided on at least a portion along a circumference of the guide gear 115. In an example, the guide gear teeth 115a may include a plurality of gear teeth. The guide gear teeth 115a may be provided to engage with the lever gear teeth 113a of the lever gear 113. The guide gear teeth 115a may be provided to correspond to the lever gear teeth 113a.

The guide gear 115 may include a gear receiving portion 115b in which the gear support portion 113b is receivable. The gear receiving portion 115b may be provided to have a length different from a length between the plurality of guide gear teeth 115a. In an example, the gear receiving portion 115b may have a length greater than the length between the plurality of guide gear teeth 115a. The gear receiving portion 115b may be provided to correspond to the size and/or shape of the gear support portion 113b.

The guide gear 115 may include an elastic member receiving portion 115c configured to receive an elastic member 117. The elastic member receiving portion 115c may have a groove shape to allow the elastic member 117 to be received. The elastic member receiving portion 115c may have a curved shape extending along a direction of rotation of the guide gear 115. The elastic member 117 may be received in the elastic member receiving portion 115c in a bent state to correspond to the curved shape along which the elastic member receiving portion 115c extends.

The guide gear 115 may include a core guide 115d configured to receive a core support portion 118a of the guide lever 118. The core guide 115d may extend from the elastic member receiving portion 115c in the direction of rotation of the guide gear 115. The core guide 115d may be connected to the elastic member receiving portion 115c. The core support portion 118a of the guide lever 118 received in the core guide 115d may be contactable the elastic member 117 received in the elastic member receiving portion 115c. The core support portion 118a of the guide lever 118 received in the core guide 115d may be supportable on the elastic member 117 received in the elastic member receiving portion 115c.

The pad moving device 110 may include the guide lever 118. The guide lever 118 may be provided to be rotatable relative to the guide gear 115. The guide lever 118 may be coupled to the pad rotating device 120. The guide lever 118 may be configured to transmit the power transmitted from the moving drive source 111 to the pad rotating device 120. The guide lever 118 may be provided to be rotatable together with the pad rotating device 120.

The guide lever 118 may include the core support portion 118a configured to be supported on the elastic member 117 received in the elastic member receiving portion 115c. The core support portion 118a may be inserted into the core guide 115d of the guide gear 115. The core support portion 118a may be slidably inserted into the core guide 115d. The core guide 115d may guide movement of the core support portion 118a. The core support portion 118a may be provided to correspond to the size and/or shape of the core guide 115d. In an example, the core support portion 118a may extend toward a lower side of the guide lever 118. For example, the core support portion 118a may protrude from a lower surface of the guide lever 118.

The guide lever 118 may include a core coupling portion 118b that is coupled to the pad rotating device 120. The core coupling portion 118b may be coupled to a gear coupling portion 125 of the pad rotating device 120. As the core coupling portion 118b of the guide lever 118 and the gear coupling portion 125 of the pad rotating device 120 are coupled, the guide lever 118 may rotate together with the pad rotating device 120. In an example, when the core coupling portion 118b of the guide lever 118 is coupled to the gear coupling portion 125 of the pad rotating device 120, the guide lever 118 may be fixed to the pad rotating device 120 as the guide lever 118 and the pad rotating device 120 are fastened by a fastening member.

The pad moving device 110 may include a bearing 119 for supporting the coupling of the core coupling portion 118b of the guide lever 118 and the gear coupling portion 125 of the pad rotating device 120. The bearing 119 may be mounted on the guide lever 118 and the pad rotating device 120 when the core coupling portion 118b of the guide lever 118 and the gear coupling portion 125 of the pad rotating device 120 are coupled.

The pad moving device 110 may include the elastic member 117. The elastic member 117 may be provided to elastically support the guide lever 118 against the guide gear 115. The elastic member 117 may be received in the elastic member receiving portion 115c of the guide gear 115. The elastic member 117 may be provided to be contractible (e.g. elastically deformable) within the elastic member receiving portion 115c. For example, the elastic member 117 may include a compression spring.

In an example, the elastic member 117 may include a first end 117a fixed to the guide gear 115. In an example, the elastic member 117 may include a second end 117b fixed to the guide lever 118 and opposite the first end 117a. For example, the elastic member 117 may include a spring.

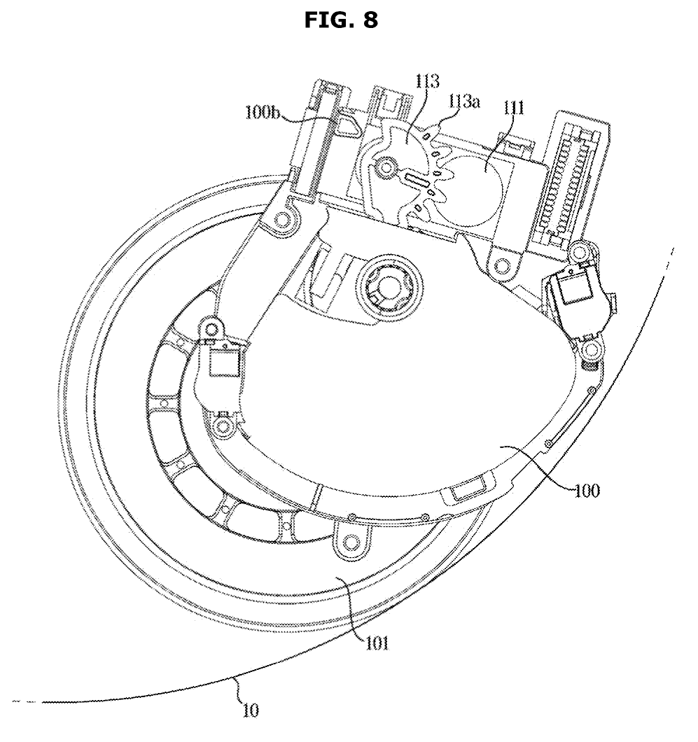

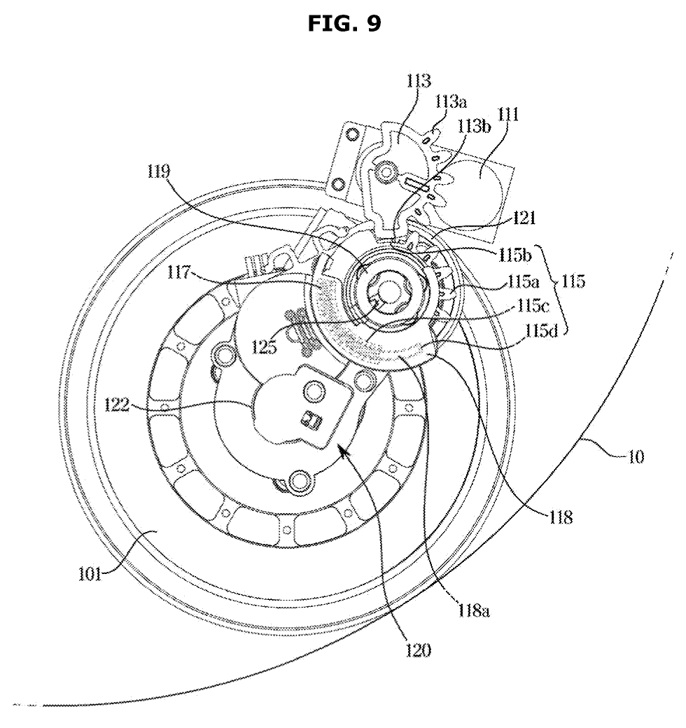

FIG. 8 illustrates a state in which a pad moving device and a pad rotating device are covered by a guide cover when the cleaning pad of the cleaner is in a first position, according to an embodiment of the present disclosure. FIG. 9 illustrates a state of the pad moving device and the pad rotating device when the cleaning pad of the cleaner is in the first position, according to an embodiment of the present disclosure.

Referring to FIGS. 8 and 9, the cleaning pad 101 of the cleaner 1 according to an embodiment of the present disclosure may be in the first position. In an example, the cleaning pad 101, while in the first position, may be rotationally driven by the pad rotating device 120 to wipe off dirt on the surface to be cleaned. The first position of the cleaning pad 101 may include a position closer to the center of the housing 10 than the second position.

When the cleaning pad 101 is in the first position, the gear support portion 113b of the lever gear 113 may be received in the gear receiving portion 115b of the guide gear 115. When the cleaning pad 101 is in the first position, the elastic member 117 may exert an elastic force in a direction in which the guide lever 118 rotates to move the cleaning pad 101 to the second position. For example, the elastic member 117 may be seated in the elastic member receiving portion 115c of the guide gear 115 so that both ends are in contact with an inner wall of the elastic member receiving portion 115c.

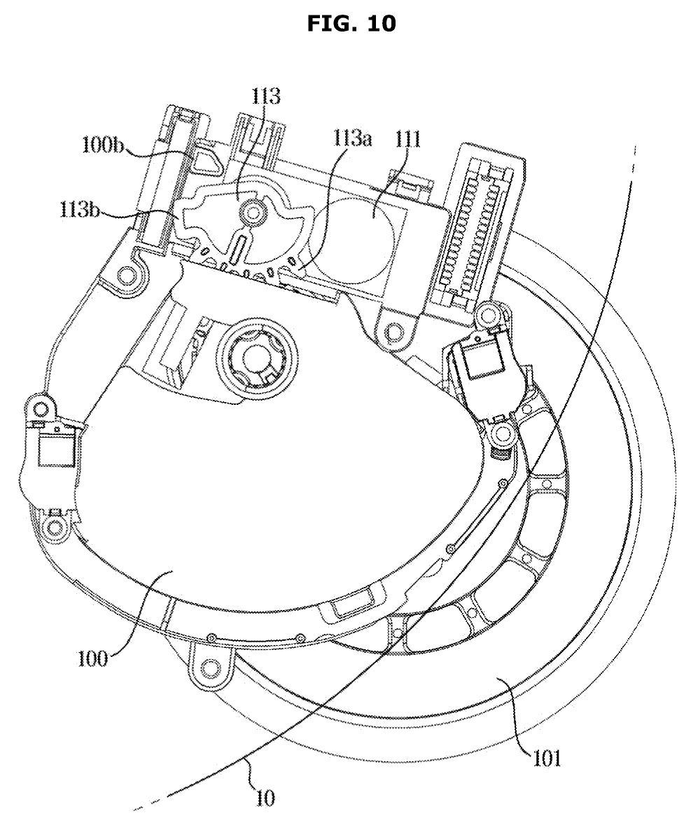

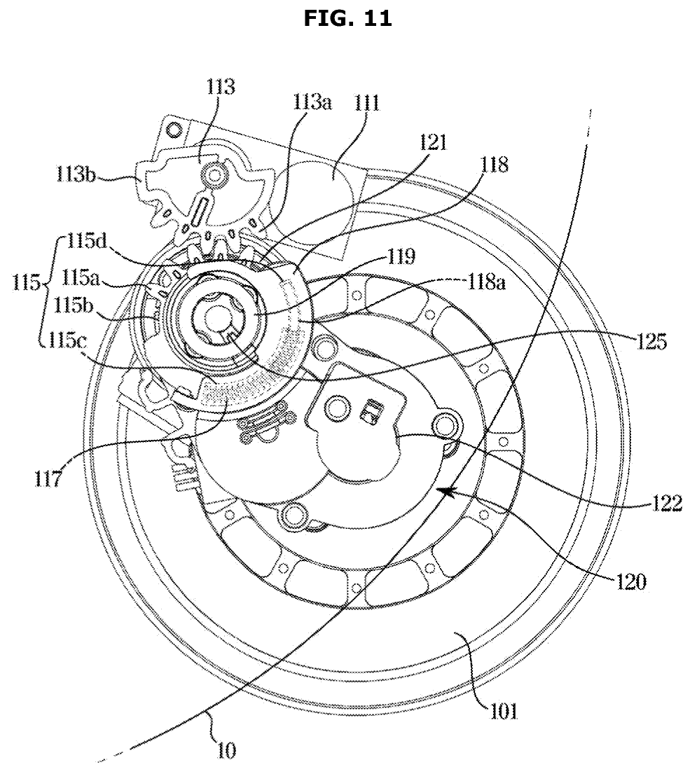

FIG. 10 illustrates a state in which the pad moving device and the pad rotating device are covered by the guide cover when the cleaning pad of the cleaner is in a second position, according to an embodiment of the present disclosure. FIG. 11 illustrates a state of the pad moving device and the pad rotating device when the cleaning pad of the cleaner is in the second position, according to an embodiment of the present disclosure.

Referring to FIGS. 10 and 11, the cleaning pad 101 of the cleaner 1 according to an embodiment of the present disclosure may be in the second position. In an example, the cleaning pad 101, while in the second position, may be rotationally driven by the pad rotating device 120 to wipe away dirt from the surface to be cleaned. The second position of the cleaning pad 101 may include a position farther from the center of the housing 10 than the first position.

The moving drive source 111 may be operable to move the cleaning pad 101 from the first position to the second position. As the moving drive source 111 is actuated, the lever gear 113 may be actuated. While the cleaning pad 101 is being moved from the first position to the second position, the lever gear 113 and the guide gear 115 may rotate with the lever gear teeth 113a and the guide gear teeth 115a meshed. For example, the lever gear 113 may rotate clockwise, and the guide gear 115 may rotate counterclockwise.

As the guide gear 115 is rotated counterclockwise by the lever gear 113, the elastic member 117 received in the elastic member receiving portion 115c of the guide gear 115 is subject to a force in the direction of compression. As the elastic member 117 receives a force in the direction of being compressed, the elastic member 117 may exert a force on the guide lever 118 through the second end 117b opposite to the first end 117a supported on the guide gear 115.

As the elastic member 117 exerts a force on the guide lever 118, the guide lever 118 is rotated counterclockwise. As the guide lever 118 rotates counterclockwise, the first portion 121 of the pad rotating device 120 on which the gear coupling portion 125 is located is rotated. As the first portion 121 of the pad rotating device 120 rotates, the second portion 122 is moved. As the second portion 122 of the pad rotating device 120 moves, the cleaning pad 101 mounted on the second portion 122 of the pad rotating device 120 moves to the second position. As the cleaning pad 101 moves to the second position, the cleaning pad 101 may protrude outwardly of the housing 10. As the cleaning pad 101 protrudes outwardly of the housing 10, the cleaner 1 may have an expanded cleaning area.

To prevent the cleaning pad 101 from protruding farther from the housing 10 than a predetermined second position, the lever stopper 100b of the guide cover 100 may limit the rotation of the lever gear 113.

In the cleaner 1 according to an embodiment of the present disclosure, as the cleaning pad 101 is provided to be movable between the first position and the second position relative to the housing 10, the area that may be cleaned by the cleaning pad 101 may be expanded.

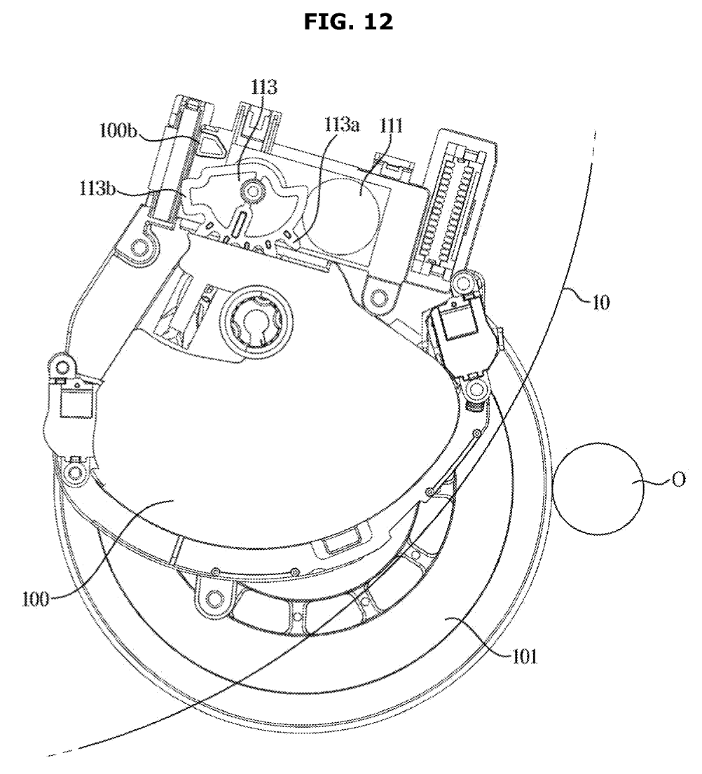

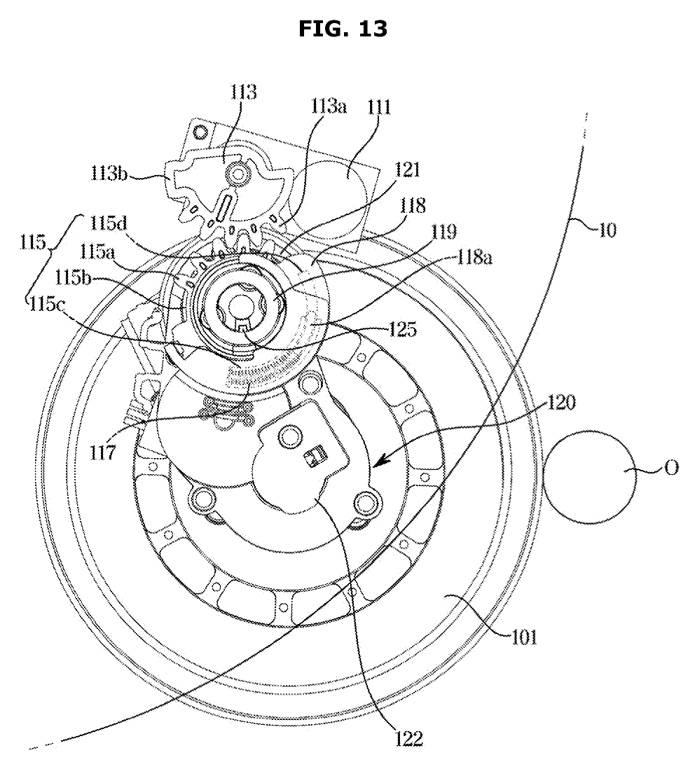

FIG. 12 illustrates a state in which the pad moving device and the pad rotating device are covered by the guide cover when the cleaning pad is in a third position as a force of a first magnitude is applied to the cleaning pad of the cleaner according to an embodiment of the present disclosure. FIG. 13 illustrates a state of the pad moving device and the pad rotating device when the cleaning pad is in the third position as the force of the first magnitude is applied to the cleaning pad of the cleaner according to an embodiment of the present disclosure.

Referring to FIGS. 12 and 13, the cleaning pad 101 of the cleaner 1 according to an embodiment of the present disclosure may be in a third position. The third position of the cleaning pad 101 may be between the first position and the second position.

In an example, while the cleaner 1 is traveling with the cleaning pad 101 in the second position, the cleaning pad 101 may collide with an obstacle O. When the cleaning pad 101 collides with the obstacle O while in the second position, the cleaning pad 101 may be subject to a force in a direction of moving to the first position. The cleaning pad 101 may be moved to the third position as the cleaning pad 101 receives a force in a direction toward the first position by the obstacle O while in the second position.

While the cleaning pad 101 is in the second position, based on a force being applied to the cleaning pad 101 in a direction toward the first position, the guide lever 118 may be provided to be rotatable to move the cleaning pad 101 to the third position between the first position and the second position. While the guide lever 118 is rotated to move the cleaning pad 101 to the second position, the elastic member 117 may be provided to exert a force on the guide lever 118 in a direction in which the guide lever 118 moves the cleaning pad to the second position.

In an example, when a force of a first magnitude is applied to the cleaning pad 101 by the obstacle O, the elastic member 117 may be contracted (e.g., elastically deformed as shown in FIG. 13) while the cleaning pad 101 is moved to the third position. While the cleaning pad 101 moves to the third position, the second portion 122 of the pad rotating device 120 may move and the first portion 121 may rotate clockwise. As the first portion 121 of the pad rotating device 120 rotates clockwise, the guide lever 118 may rotate clockwise. As the guide lever 118 rotates clockwise, the core support portion 118a of the guide lever 118 may exert a force on the elastic member 117 in a direction that compresses the elastic member 117 (e.g., elastically deforms the elastic member 117 in a direction of compression of the elastic member 117 as shown in FIG. 13). When the force of the first magnitude is applied to the cleaning pad 101, the lever gear 113 and the guide gear 115 may not rotate due to a supporting force of the moving drive source 111.

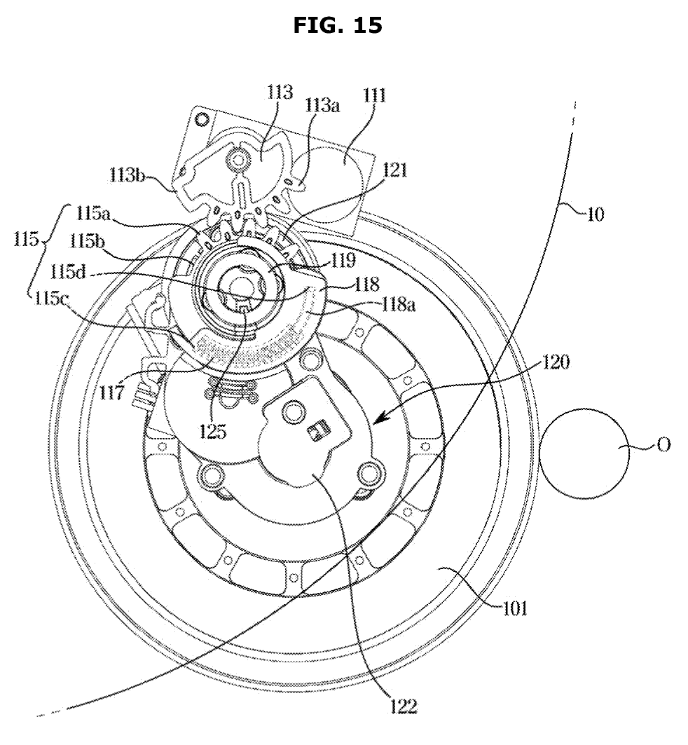

In an example, when the force applied to the cleaning pad 101 by the obstacle O is removed, the elastic member 117 may be tensioned (e.g., returned to an undeformed state as shown in FIG. 15). As the elastic member 117 is tensioned, the guide lever 118 may rotate counterclockwise. As the guide lever 118 rotates counterclockwise, the first portion 121 of the pad rotating device 120 may rotate counterclockwise, and the second portion 122 may move. As the second portion 122 of the pad rotating device 120 moves, the cleaning pad 101 may return to the second position.

In an example, when the cleaning pad 101 fails to return to the second position due to the elastic force of the elastic member 117, the moving drive source 111 may rotate the lever gear 113. For example, as the lever gear 113 is rotated clockwise by the moving drive source 111, the guide gear 115 may rotate counterclockwise. As the rotational force of the guide gear 115 is transmitted to the guide lever 118 by the elastic member 117, the guide lever 118 may rotate counterclockwise. As the guide lever 118 rotates counterclockwise, the first portion 121 of the pad rotating device 120 may rotate counterclockwise, and the second portion 122 may move. As the second portion 122 of the pad rotating device 120 moves, the cleaning pad 101 may return to the second position.

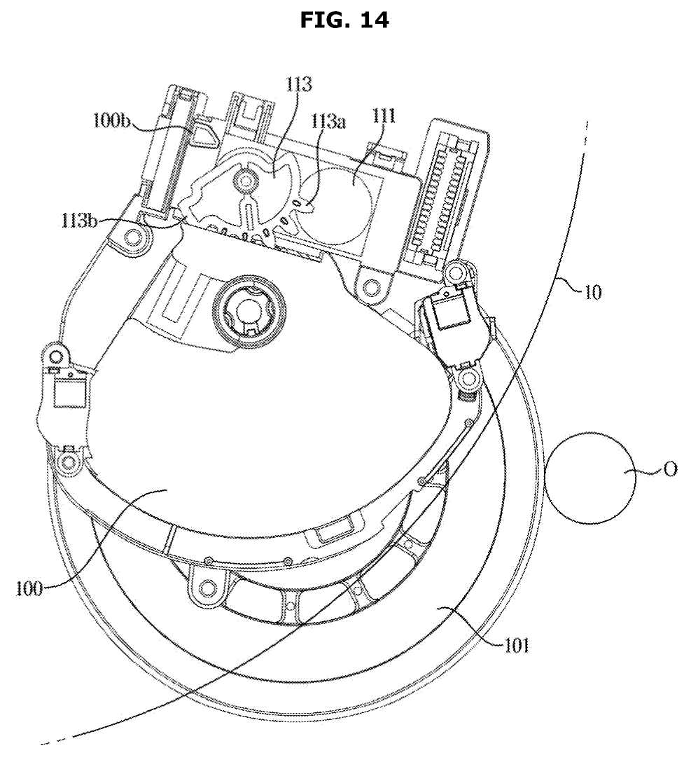

FIG. 14 illustrates a state in which the pad moving device and the pad rotating device are covered by the guide cover when the cleaning pad is in the third position as a force of a second magnitude is applied to the cleaning pad of the cleaner according to an embodiment of the present disclosure. FIG. 15 illustrates a state of the pad moving device and the pad rotating device when the cleaning pad is in the third position as the force of the second magnitude is applied to the cleaning pad of the cleaner according to an embodiment of the present disclosure.

Referring to FIGS. 14 and 15, the cleaning pad 101 of the cleaner 1 according to an embodiment of the present disclosure may be in the third position. In an example, in contrast to the case where a force of a first magnitude is applied to the cleaning pad 101 as shown in FIGS. 12 and 13, referring to FIGS. 14 and 15, a force of a second magnitude greater than the force of the first magnitude may be applied to the cleaning pad 101. For example, the force of the second magnitude may include a force greater than the supporting force of the moving drive source 111.

While the cleaning pad 101 is in the second position, based on a force being applied to the cleaning pad 101 in a direction toward the first position, the guide lever 118 may be provided to be rotatable to move the cleaning pad 101 to the third position between the first position and the second position. For example, the third position may include any position between the first position and the second position. While the guide lever 118 is rotated to move the cleaning pad 101 to the second position, the elastic member 117 may be configured to apply a force to the guide lever 118 in a direction that causes the guide lever 118 to move the cleaning pad to the second position.

When the cleaning pad 101 is in the second position, the operation of the moving drive source 111 may be stopped. When the force of the second magnitude is applied to the cleaning pad 101, the lever gear 113 connected to the moving drive source 111 may rotate to move the cleaning pad 101 toward the first position. When the force of the second magnitude is applied to the cleaning pad 101, the second portion 122 of the pad rotating device 120 connected to the cleaning pad 101 is moved, and the first portion 121 of the pad rotating device 120 is rotated. As the first portion 121 rotates, the guide lever 118 may rotate clockwise. As the guide lever 118 rotates, a force may be applied to the elastic member 117 in a direction that compresses the elastic member 117. As the force is applied to the elastic member 117, the elastic member 117 may cause the guide gear 115 to rotate. As the guide gear 115 rotates clockwise, the lever gear 113 rotates counterclockwise.

In an example, when the force applied to the cleaning pad 101 by the obstacle O is removed, the moving drive source 111 may be actuated to move the cleaning pad 101 to the second position. As the moving drive source 111 is actuated, the lever gear 113 may rotate clockwise. As the lever gear 113 rotates, the guide gear 115 may rotate counterclockwise. As the guide gear 115 rotates counterclockwise, the elastic member 117 may transmit the force received from the guide gear 115 to the guide lever 118. The force applied by the elastic member 117 may cause the guide lever 118 to rotate counterclockwise. As the guide lever 118 rotates, the first portion 121 of the pad rotating device 120 may rotate counterclockwise, and the second portion 122 moves. As the second portion 122 moves, the cleaning pad 101 may move to the second position.

In an example, while a controller 90 operates the moving drive source 111 to move the cleaning pad 101 to the second position, the movement of the cleaning pad 101 may be restricted by an obstacle. While the controller 90 operates the moving drive source 111 to move the cleaning pad 101 to the second position, based on the restricted movement of the cleaning pad 101 to the second position, the elastic member 117 may be configured to be contractible.

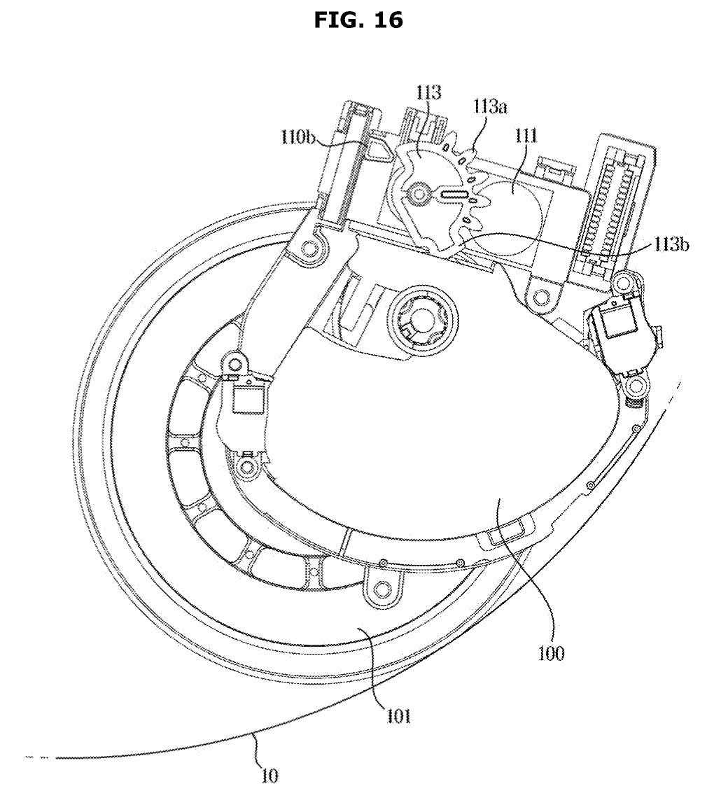

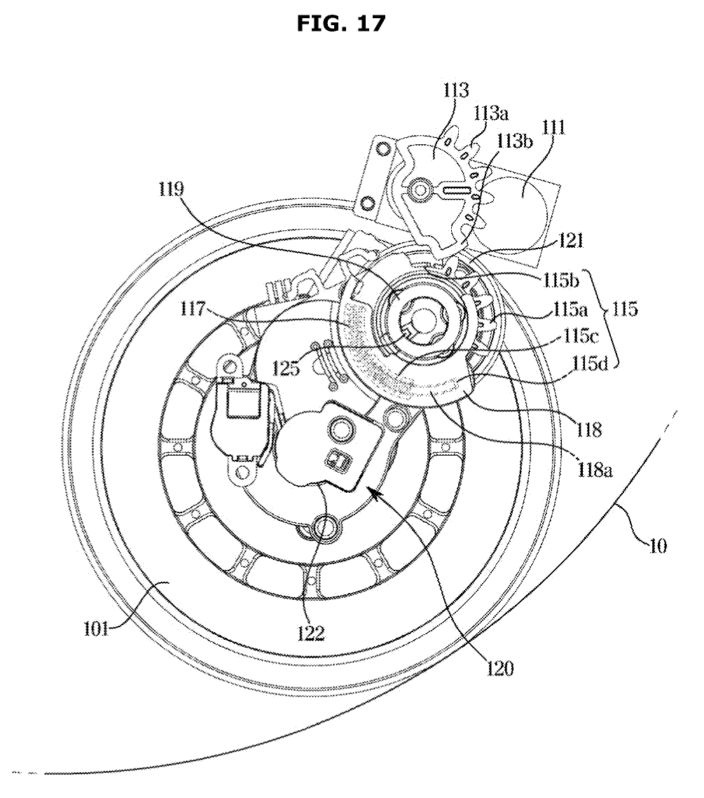

FIG. 16 illustrates a state in which the pad moving device and the pad rotating device are covered by the guide cover when the lever gear is in a support position while the cleaning pad of the cleaner is in the first position, according to an embodiment of the present disclosure. FIG. 17 illustrates a state of the pad moving device and the pad rotating device when the lever gear is in the support position while the cleaning pad of the cleaner is in the first position, according to an embodiment of the present disclosure.

Referring to FIGS. 16 and 17, when the cleaning pad 101 of the cleaner 1 according to an embodiment of the present disclosure is in the first position, the lever gear 113 may be in a support position. In an example, when the cleaning pad 101 is rotated clockwise by the pad rotating device 120 in the first position, the cleaning pad 101 may receive a force in a direction of moving to the second position due to a frictional force between the cleaning pad 101 and the surface to be cleaned. The lever gear 113 may prevent the cleaning pad 101 from moving to the second position while the cleaning pad 101 is rotating in the first position.

To prevent the cleaning pad 101 from moving to the second position while the cleaning pad 101 is rotationally driven in the first position, the lever gear 113 may be provided to be rotatable to a support position in which the gear support portion 113b supports the guide gear 115. The support position of the lever gear 113 may be reached by rotating the lever gear 113 in a direction opposite to a direction in which the lever gear 113 is rotated to move the cleaning pad 101 from the first position to the second position.

The gear support portion 113b of the lever gear 113 may support the guide gear teeth 115a of the guide gear 115. The gear support portion 113b of the lever gear 113 may support the guide gear teeth 115a to prevent the guide gear 115 from rotating in a direction in which the guide gear 115 rotates to move the cleaning pad 101 from the first position to the second position. With such a configuration, the cleaner 1 of an embodiment of the present disclosure may reduce the cleaning pad 101 from deviating from the first position and moving to the second position while the cleaning pad 101 is rotating in the first position.

With the cleaning pad 101 in the first position, when the lever gear 113 is rotated farther than a predetermined support position, the rotation of the lever gear 113 may be limited by the lever stopper 100b of the guide cover 100. The lever stopper 100b may limit the range of rotation of the lever gear 113 in one direction and the range of rotation in a direction opposite to the one direction.

In an example, the position at which the gear support portion 113b of the lever gear 113 supports the guide gear teeth 115a of the guide gear 115 may be provided such that a side opposite to a rotation axis of the cleaning pad 101 is positioned relative to a line connecting a rotation axis of the lever gear 113 and a rotation axis of the guide gear 115.

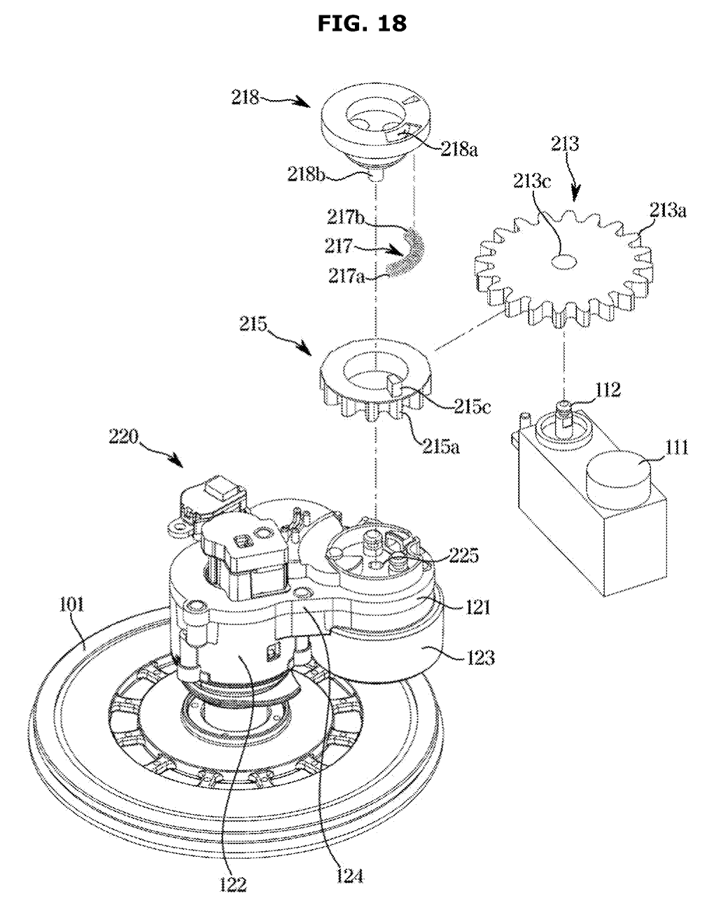

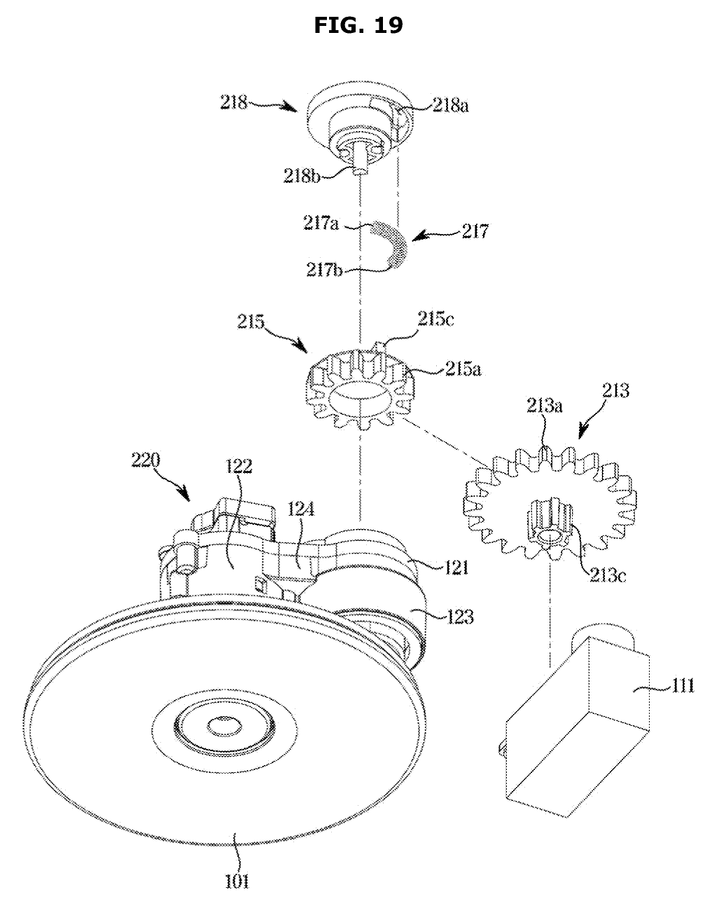

FIG. 18 is an exploded upper perspective view of a pad moving device of a cleaner according to an embodiment of the present disclosure. FIG. 19 is an exploded lower perspective view of the pad moving device of the cleaner according to an embodiment of the present disclosure.

In describing the cleaning pad 101, a pad rotating device 220, and a pad moving device 210 shown in FIGS. 18 and 19, the same reference numerals are assigned to configurations that are the same as those of the cleaning pad 101, the pad rotating device 120, and the pad moving device 110 shown in FIGS. 6 and 7, and a detailed description thereof may be omitted.

Referring to FIGS. 18 and 19, the cleaner 1 according to an embodiment of the present disclosure may include the cleaning pad 101, the pad rotating device 220, and the pad moving device 210. The cleaning pad 101 may be mounted on the pad rotating device 220. The pad rotating device 220 may be connected to the pad moving device 210.

The pad moving device 210 may include the moving drive source 111 configured to generate power to move the cleaning pad 101.

The pad moving device 210 may include a lever gear 213 connected to the axle shaft 112 of the moving drive source 111. As the moving drive source 111 operates, the lever gear 213 may rotate. In contrast to the lever gear 113 shown in FIGS. 6 and 7, the lever gear 213 shown in FIGS. 18 and 19 may be provided with lever gear teeth 213a arranged continuously along its circumference, and the configuration of the gear support portion 113b shown in FIGS. 6 and 7 may be omitted. The lever gear 213 may include a shaft insertion portion 213c connected to the axle shaft 112.

The pad moving device 210 may include a guide gear 215 that is rotatable based on rotation of the lever gear 213. The guide gear 215 may include guide gear teeth 215a that mesh with the lever gear teeth 213a of the lever gear 213.

The pad moving device 210 may include a guide lever 218 provided to be rotatable relative to the guide gear 215.

Unlike the guide gear 115 and the guide lever 118 shown in FIGS. 6 and 7, the guide gear 215 and the guide lever 218 shown in FIGS. 18 and 19 may be provided such that an elastic member 217 is received in the guide lever 218.

The guide gear 215 may include a guide support portion 215c for supporting a first end 217a of the elastic member 217. The guide support portion 215c may be slidably inserted into an elastic member receiving portion 218a of the guide lever 218. The elastic member 217 may be received in the elastic member receiving portion 218a of the guide lever 218. A second end 217b of the elastic member 217 may be supported in a state of being received in the elastic member receiving portion 218a of the guide lever 218. The elastic member 217 may elastically support the guide lever 218 in a direction in which the guide lever 218 rotates to move the cleaning pad 101 from the first position to the second position.

The guide lever 218 may include a core coupling portion 218b coupled to the pad rotating device 220. The pad rotating device 220 may include a gear coupling portion 225 to which the core coupling portion 218b to be coupled.

With such a configuration, the pad moving device 210 may move the cleaning pad 101 to the first position and the second position. With such a configuration, when a force is applied to the cleaning pad 101 in a direction of moving to the first position while the cleaning pad 101 is in the second position, the pad moving device 210 may move to the third position between the first position and the second position, and when the force applied to the cleaning pad 101 is removed, the pad moving device 210 may return to the second position.

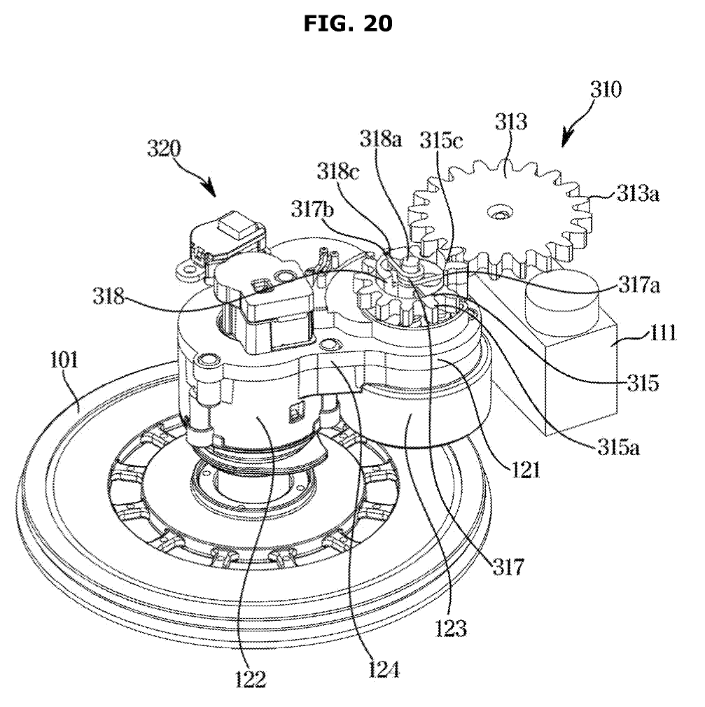

FIG. 20 illustrates a pad rotating device and a pad moving device for driving a cleaning pad of a cleaner according to an embodiment of the present disclosure.

In describing the cleaning pad 101, a pad rotating device 320, and a pad moving device 310 shown in FIG. 20, the same reference numerals are assigned to configurations that are the same as those of the cleaning pad 101, the pad rotating device 120, and the pad moving device 110 shown in FIGS. 6 and 7, and the cleaning pad 101, the pad rotating device 220, and the pad moving device 210 shown in FIGS. 18 and 19, and a detailed description thereof may be omitted.

Referring to FIG. 20, the cleaner 1 according to an embodiment of the present disclosure may include the cleaning pad 101, the pad rotating device 320, and the pad moving device 310. The cleaning pad 101 may be mounted on the pad rotating device 320. The pad rotating device 320 may be connected to the pad moving device 310.

The pad moving device 310 may include the moving drive source 111 configured to generate power to move the cleaning pad 101.

The pad moving device 310 may include a lever gear 313 connected to the moving drive source 111. As the moving drive source 111 operates, the lever gear 313 may rotate. The lever gear 313 shown in FIG. 20 may have a configuration similar to the lever gear 213 shown in FIGS. 18 and 19. The lever gear 313 may be provided with lever gear teeth 213a arranged continuously along its circumference.

The pad moving device 310 may include a guide gear 315 that is rotatable based on rotation of the lever gear 313. The guide gear 315 may include guide the gear teeth 315a that mesh with the lever gear teeth 313a of the lever gear 313.

The pad moving device 310 may include a guide lever 318 provided to be rotatable relative to the guide gear 315. The guide lever 318 may be rotatably coupled to the guide gear 315.

The pad moving device 310 shown in FIG. 20 may include an elastic member 317 having a first end 317a fixed to the guide gear 315 and a second end 317b fixed to the guide lever 318. In an example, the elastic member 317 may include a torsion spring. The elastic member 317 may be mounted on an elastic member mounting part 318a of the guide lever 318. The first end 317a of the elastic member 317 may be fixed to a guide support portion 315c formed on the guide gear 315, and the second end 317b of the elastic member 317 may be fixed to a core support portion 318c formed on the guide lever 318.

The elastic member 317 may elastically support the guide lever 318 in a direction in which the guide lever 318 rotates to move the cleaning pad 101 from the first position to the second position.

The guide lever 318 may be coupled to the pad rotating device 320. The coupling configuration of the guide lever 318 and the pad rotating device 320 shown in FIG. 20 may be provided similarly to the coupling configuration of the guide lever 218 and the pad rotating device 220 shown in FIGS. 18 and 19.

With such a configuration, the pad moving device 310 may move the cleaning pad 101 to the first position and the second position. With such a configuration, when a force is applied to the cleaning pad 101 in a direction of moving to the first position while the cleaning pad 101 is in the second position, the pad moving device 310 may move to the third position between the first position and the second position, and when the force applied to the cleaning pad 101 is removed, the pad moving device 310 may return to the second position.

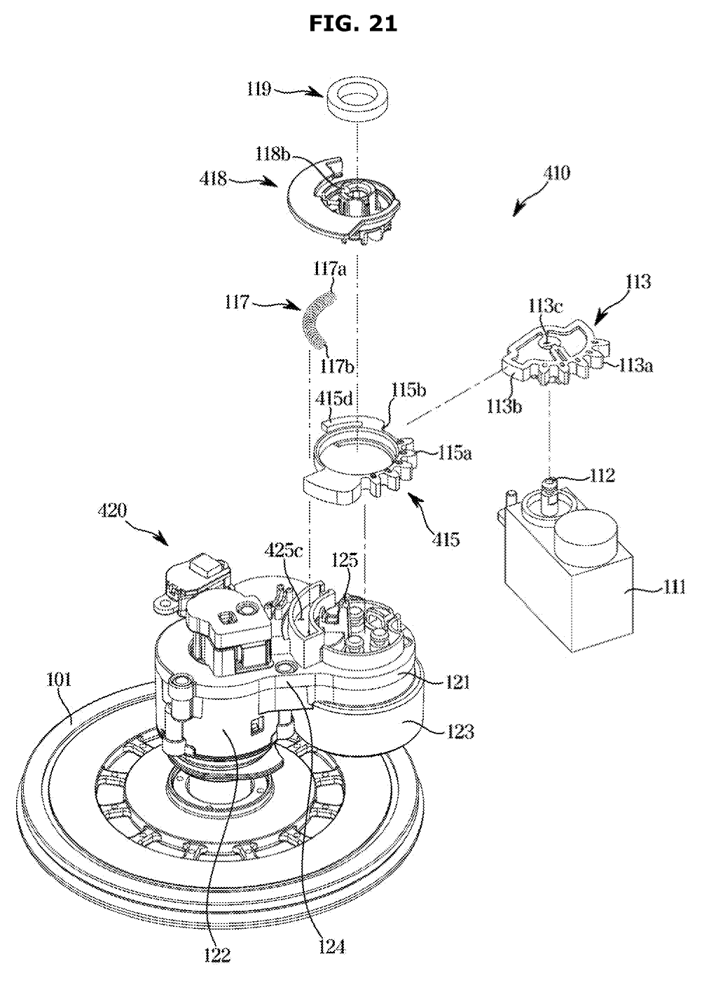

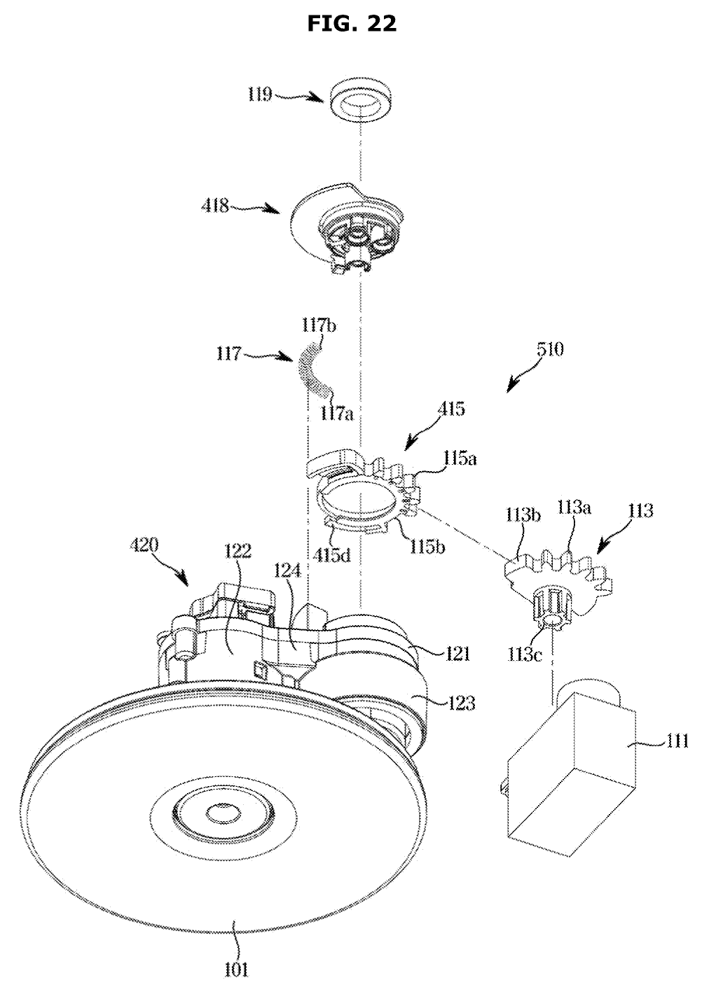

FIG. 21 is an exploded upper perspective view of a pad moving device of a cleaner according to an embodiment of the present disclosure. FIG. 22 is an exploded lower perspective view of the pad moving device of the cleaner according to an embodiment of the present disclosure.

In describing the cleaning pad 101, a pad rotating device 420, and a pad moving device 410 shown in FIGS. 21 and 22, the same reference numerals are assigned to configurations that are the same as those of the cleaning pad 101, the pad rotating device 120, and the pad moving device 110 shown in FIGS. 6 and 7, and a detailed description thereof may be omitted.

Referring to FIGS. 21 and 22, the cleaner 1 according to an embodiment of the present disclosure may include the cleaning pad 101, the pad rotating device 420, and the pad moving device 410. The cleaning pad 101 may be mounted on the pad rotating device 420. The pad rotating device 420 may be connected to the pad moving device 410.

The pad moving device 410 may include the moving drive source 111 configured to generate power to move the cleaning pad 101.

The pad moving device 410 may include the lever gear 113 connected to an axle shaft 112 of the moving drive source 111. As the moving drive source 111 operates, the lever gear 113 may rotate. The lever gear 113 may include the lever gear teeth 113a, the gear support portion 113b, and the shaft insertion portion 113c.

The pad moving device 410 may include a guide gear 415 that is rotatable based on rotation of the lever gear 113. The guide gear 415 may include guide the gear teeth 115a that mesh with the lever gear teeth 113a of the lever gear 113. The guide gear 415 may include the gear receiving portion 115b that is receivable by the gear support portion 113b of the lever gear 113.

The pad moving device 410 may include a guide lever 418 provided to be rotatable together with the pad rotating device 420. The guide lever 418 may include the core coupling portion 118b coupled to the pad rotating device 420. The core coupling portion 118b may be coupled to the gear coupling portion 125 of the pad rotating device 420.

The pad moving device 410 may include the bearing 119 for supporting the coupling of the core coupling portion 118b of the guide lever 418 and the gear coupling portion 125 of the pad rotating device 420.

The elastic member 117 according to an embodiment of the present disclosure may be received in the pad rotating device 420. The pad rotating device 420 may include an elastic member receiving portion 425c. With the elastic member 117 received in the elastic member receiving portion 425c, the first end 117a may be supported by a guide support portion 415d of the guide gear 415. With the elastic member 117 received in the elastic member receiving portion 425c, the second end 117b may be supported by the pad rotating device 420.

The guide gear 415 may include a guide support portion 415d for supporting the first end 117a of the elastic member 117. The guide support portion 415d may be slidably inserted into the elastic member receiving portion 425c of the pad rotating device 420.

With such a configuration, the pad moving device 410 may move the cleaning pad 101 to the first position and the second position. For example, as the moving drive source 111 operates, the lever gear 113 may rotate, as the lever gear 113 rotates, the guide gear 415 may rotate, and as the guide gear 415 rotates, the guide support portion 415d of the guide gear 415 may apply a force to the first end 117a of the elastic member 117. As a force is applied to the first end 117a of the elastic member 117 by the guide support portion 415d, the second end 117b of the elastic member 117 may apply a force to the pad rotating device 420, and as the pad rotating device 420 and the guide lever 418 rotate, the cleaning pad 101 may be moved from the first position to the second position.

With such a configuration, when a force is applied to the cleaning pad 101 in a direction of moving to the first position while the cleaning pad 101 is in the second position, the pad moving device 410 may move to the third position between the first position and the second position, and when the force applied to the cleaning pad 101 is removed, the pad moving device 410 may return to the second position.

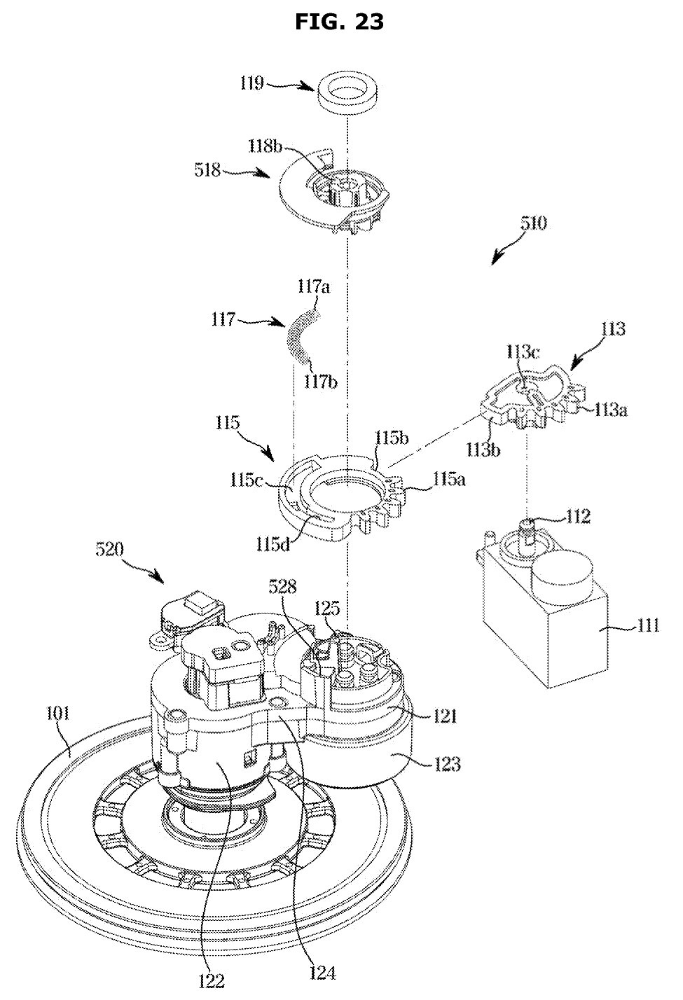

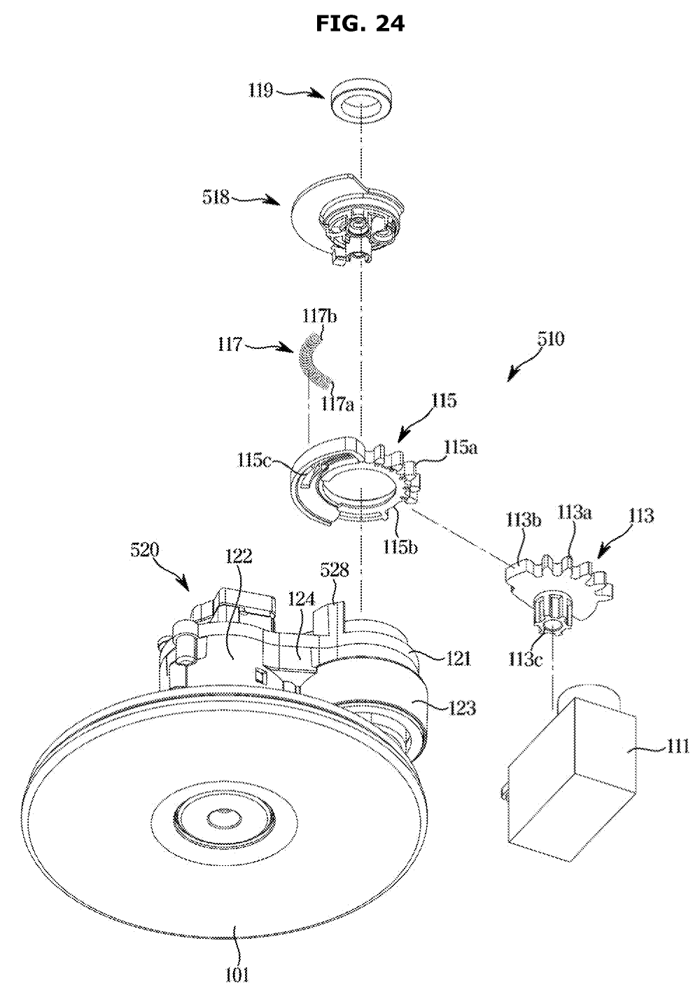

FIG. 23 is an exploded upper perspective view of a pad moving device of a cleaner according to an embodiment of the present disclosure. FIG. 24 is an exploded lower perspective view of the pad moving device of the cleaner according to an embodiment of the present disclosure.

In describing the cleaning pad 101, a pad rotating device 520, and a pad moving device 510 shown in FIGS. 23 and 24, the same reference numerals are assigned to configurations that are the same as those of the cleaning pad 101, the pad rotating device 120, and the pad moving device 110 shown in FIGS. 6 and 7, and a detailed description thereof may be omitted.

Referring to FIGS. 23 and 24, the cleaner 1 according to an embodiment of the present disclosure may include the cleaning pad 101, the pad rotating device 520, and the pad moving device 510. The cleaning pad 101 may be mounted on the pad rotating device 520. The pad rotating device 520 may be connected to the pad moving device 510.

The pad moving device 510 may include the moving drive source 111 configured to generate power to move the cleaning pad 101.

The pad moving device 510 may include the lever gear 113 connected to the axle shaft 112 of the moving drive source 111. As the moving drive source 111 operates, the lever gear 113 may rotate. The lever gear 113 may include the lever gear teeth 113a, the gear support portion 113b, and the shaft insertion portion 113c.

The pad moving device 510 may include the guide gear 115 that is rotatable based on the rotation of the lever gear 113. The guide gear 115 may include guide the gear teeth 115a that mesh with the lever gear teeth 113a of the lever gear 113. The guide gear 115 may include the gear receiving portion 115b that is receivable by the gear support portion 113b of the lever gear 113. The guide gear 115 may include the elastic member receiving portion 115c for receiving an elastic member 117.

The guide gear 115 may include the core guide 115d for receiving a core support portion 528 of the pad rotating device 520. The pad rotating device 520 may include the core support portion 528. The core support portion 528 may be slidably inserted into the core guide 115d.

The pad moving device 510 may include a guide lever 518 provided to be rotatable together with the pad rotating device 520. The guide lever 518 may include the core coupling portion 118b coupled to the pad rotating device 520. The core coupling portion 118b may be coupled to the gear coupling portion 125 of the pad rotating device 520.

The pad moving device 510 may include the bearing 119 for supporting the coupling of the core coupling portion 118b of the guide lever 518 and the gear coupling portion 125 of the pad rotating device 520.

The elastic member 117 according to an embodiment of the present disclosure may be received in the guide gear 115. The elastic member 117 may be received in the elastic member receiving portion 115c of the guide gear 115. With the elastic member 117 received in the elastic member receiving portion 115c, the first end 117a may be supported by the guide gear 115. With the elastic member 117 received in the elastic member receiving portion 115c, the second end 117b may be supported by the core support portion 528 of the pad rotating device 420. With the core support portion 528 in contact with the second end 117b of the elastic member 117, a force may be applied to the elastic member 117.

With such a configuration, the pad moving device 410 may move the cleaning pad 101 to the first position and the second position. For example, as the moving drive source 111 operates, the lever gear 113 may rotate, as the lever gear 113 rotates, the guide gear 115 may rotate, and as the guide gear 115 rotates, a force may be applied to the elastic member 117 received in the guide gear 115. The elastic member 117, which has received the force from the rotation of the guide gear 115, may apply a force to the pad rotating device 520 via the core support portion 528. As a force is applied to the pad rotating device 520, the cleaning pad 101 may be moved from the first position to the second position as the pad rotating device 520 and the guide lever 518 rotate.

With such a configuration, when a force is applied to the cleaning pad 101 in a direction of moving to the first position while the cleaning pad 101 is in the second position, the pad moving device 510 may move to the third position between the first position and the second position, and when the force applied to the cleaning pad 101 is removed, the pad moving device 510 may return to the second position.

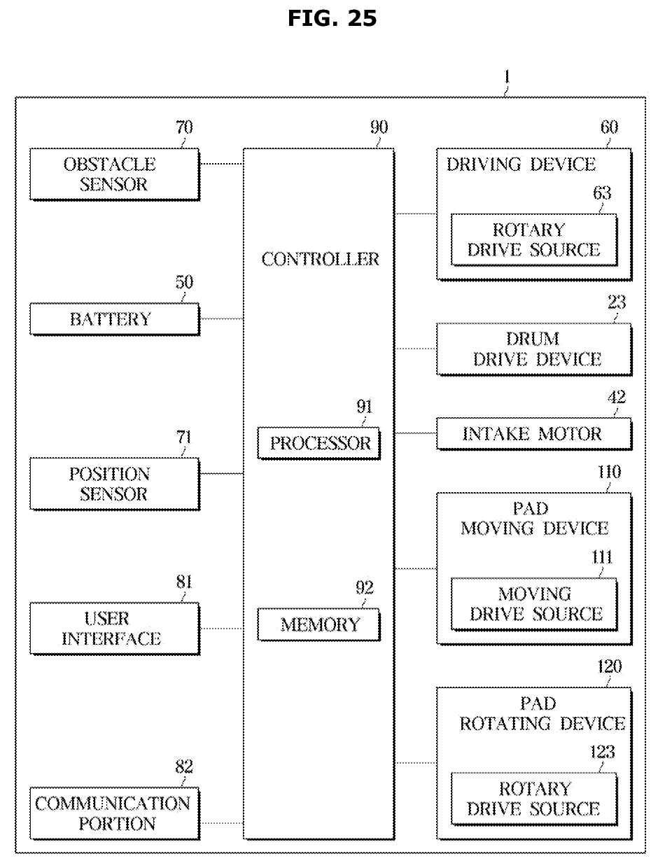

FIG. 25 is a control block diagram of a cleaner according to an embodiment of the present disclosure.

Referring to FIG. 25, the cleaner 1 according to an embodiment may include the obstacle sensor 70, the position sensor 71, the battery 50, the user interface 81, the pad moving device 110, the pad rotating device 120, a drum drive device 23, the intake motor 42, a communication portion 82, and/or the controller 90.

The obstacle sensor 70 may detect an obstacle that impede the travel of the cleaner 1. An obstacle may refer to any object that protrudes from the floor of the cleaning area and impedes the travel of the cleaner 1. For example, obstacles may include furniture, such as tables, sofas, and the like located in the cleaning area, as well as walls that divide the space, and objects that the cleaner 1 may climb over and descend from, such as thresholds or bars,.

Specifically, the obstacle sensor 70 may detect an obstacle in a non-contact manner using electromagnetic waves, such as infrared light, visible light, or ultrasound. For example, the obstacle sensor 70 may irradiate infrared light, detect the infrared light reflected from an obstacle, and output the intensity of the detected infrared light, or a time interval from the irradiation of the infrared light to the detection of the reflected infrared light (time of flight: TOF) to the controller 90.

The controller 90 may calculate the presence or absence of an obstacle or a distance between the obstacle and the cleaner 1 based on the output value of the obstacle sensor 70.

In another example, the obstacle sensor 70 may include a transmitting portion (e.g., transmitter) that emits electromagnetic waves and a receiving portion (e.g., receiver) that receives the electromagnetic waves reflected from the obstacle.

The transmitting portion may be provided at a front of the housing 10 and may transmit electromagnetic waves toward the front of the housing 10. In addition, depending on an embodiment, the transmitting portion may include a light emitting diode (LED) that generates electromagnetic waves and a wide-angle lens that diffuses the electromagnetic waves in all directions by refracting the transmitted electromagnetic waves.

In another example, the obstacle sensor 70 may include a camera that acquires an image of a neighborhood (e.g., front, rear, and/or side) of the cleaner 1.

The controller 90 may calculate the presence or absence of an obstacle or a distance between the obstacle and the cleaner 1 based on the image acquired by the obstacle sensor 70.

The position sensor 71 may be provided to detect a position of the cleaning pad 101. For example, the position sensor 71 may include a sensor that detects the cleaning pad 101 being deviated from the second position.

The battery 50 may supply power to various electronic components of the cleaner 1. The battery 50 may be charged while the cleaner 1 is docked at a station.

The cleaner 1 may include a battery sensor that detects the state of charge of the battery 50.

The controller 90 may control the driving device 20 to direct the cleaner 1 to return to the station when the state of charge of the battery 50 falls below a given state of charge.

The user interface 81 may include an output interface and an input interface.

At least one output interface may generate sensory information to communicate various information to the user regarding to the behavior of the cleaner 1 to a user.

For example, the at least one output interface may convey information related to the settings of the cleaner 1 and the operating time of the cleaner 1 to the user. Information regarding the operation of the cleaner 1 may be output as a display, an indicator, and/or a voice. The at least one output interface may include, for example, a liquid crystal display (LCD) panel, an indicator, an LED panel, a speaker, or the like.

When the display includes a touch screen display, the touch screen display may be one example of an output interface and an input interface.

In an embodiment, the at least one output interface may output sensory information (e.g., visual information, auditory information, etc.) related to the control of the cleaner 1.

The at least one input interface may convert sensory information received from the user into an electrical signal.

The at least one input interface may include a power button for turning on the power of the cleaner 1.

Each button may include a visual indicator (e.g., text, icon, etc.) that may indicate its function.

The at least one input interface may include, for example, a tact switch, a push switch, a slide switch, a toggle switch, a micro switch, a touch switch, a touch pad, a touch screen, a jog dial, and/or a microphone.

As used herein, ‘button’ may be replaced by a user interface (UI) element, a tact switch, a push switch, a slide switch, a toggle switch, a micro switch, a touch switch, a touch pad, a touch screen, a jog dial, and/or a microphone.

The cleaner 1 may process user input received via the user interface 81 and output information related to the cleaner 1 via the user interface 81.

In an embodiment, the user interface 81 may include an input interface for receiving a cleaning pad wash command and/or a cleaning pad steam command.

When the user determines that the cleaning pad 101 of the cleaner 1 needs to be cleaned or sterilized, the user may input a cleaning pad wash command and/or a cleaning pad steam command via the input interface.

Once a cleaning pad wash command and/or a cleaning pad steam command is input via the input interface, the cleaner 1 may return to the station.

When the cleaning pad wash command and/or the cleaning pad steam command is input via the input interface, the cleaner 1 may transmit a cleaning pad wash request signal and/or a cleaning pad steam request signal to the station.

Accordingly, when the cleaner 1 subsequently returns to the station and is docked to the station, the station may perform a washing process (e.g., a wash process and/or a steam process).

The driving device 60 may include a rotary drive source 63 for providing rotational power to the driving wheels 61.

The driving wheels 61 may move the housing 10 by rotation. The rotation of the driving wheels 61 may cause the housing 10 may move forward, backward, or rotate. For example, when both the left and right driving wheels 61 rotate forward, the housing 10 moves straight forward, and when both the left and right driving wheels 61 rotate backward, the housing 10 may move straight backward.

In addition, when the left and right driving wheels 61 rotate in the same direction but at different speeds, the housing 10 may move in a curved motion to the right or left, and when the left and right driving wheels 61 rotate in different directions, the housing 10 may rotate in place to the left or right.

A wheel motor may generate a rotational force to rotate the driving wheels 61. A DC motor or a BLDC motor may be employed as the wheel motor, but embodiments of the cleaner 1 are not limited to the type of wheel motor. The same may apply to other motors included in the cleaner 1 as well as the wheel motor.

The wheel motor may include a left wheel motor for rotating a left traveling wheel and a right wheel motor for rotating a right traveling wheel.

Each of the left and right wheel motors may operate independently of each other in response to a control signal from the controller 90, and the housing 10 may move forward, backward, or rotate in response to the operation of the left and right wheel motors.

The controller 90 may control the movement of the cleaner 1 by controlling the driving device 60 (e.g., the wheel motors).

The drum drive device 23 may rotate the drum 22.

The controller 90 may control the drum drive device 23 to rotate the drum 22 during dry cleaning, thereby causing foreign matter on the floor to be scattered by the drum 22.

The intake motor 42 may draw the foreign matter scattered by the drum 22 into the dust collector 40, and may rotate an intake fan to generate an intake force to draw the foreign matter into the dust collector 40.

The controller 90 may control the intake motor 42 to rotate the intake fan during dry cleaning, thereby causing the foreign matter scattered by the drum 22 to be drawn into the dust collector 40 through the intake inlet 11.

The controller 90 may adjust the intensity of the intake motor 42. The intensity of the intake motor 42 may correspond to a rotational speed of the intake motor 42 and/or a duty ratio of the intake motor 42.

The controller 90 may move the cleaning pad 101 to the first position and the second position by controlling the pad moving device 110. The pad moving device 110 may include the moving drive source 111 for moving the cleaning pad 101 and the drive circuitry for driving the moving drive source 111.

The controller 90 may rotate the cleaning pad 100 by controlling the pad rotating device 120. The pad rotating device 120 may include the rotary drive source 123 for rotating the cleaning pad 101 and a drive circuitry for driving the rotary drive source 123.

The communication portion 82 may be in wired and/or wireless communication with an external device (e.g., server, user device, station).

The communication portion 82 may transmit data to an external device (e.g., server, user device, station) and/or receive data from the external device. To this end, the communication portion 82 may support the establishment of a direct (e.g., wired) or wireless communication channel between external devices, and the conduct of communication over the established communication channels. According to an embodiment, the communication portion 82 may include a wireless communication module (e.g., a cellular communication module, a short-range wireless communication module, or a global navigation satellite system (GNSS) communication module) or a wired communication module (e.g., a local area network (LAN) communication module, or a power line communication module). Any of these communication modules may communicate with an external device via a first network (e.g., a short-range communication network such as Bluetooth, wireless fidelity (Wi-Fi) Direct, or infrared data association (IrDA)) or a second network (e.g., a long-range communication network such as a legacy cellular network, a 5G network, a next-generation communication network, the Internet, or a computer network (e.g., LAN or WAN)). These different types of communication modules may be integrated into a single component (e.g., a single chip) or implemented as a plurality of separate components (e.g., a plurality of chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+ communication module, a microwave (uWave) communication module, and the like, but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

In an embodiment, the communication portion 82 may communicate with external devices via a nearby access point (AP). The AP may connect a LAN to which the cleaner 1 is connected to a WAN to which a server is connected. The cleaner 1 may be connected to the server via the WAN.

In an embodiment, the communication portion 82 may communicate with the station wirelessly.

The controller 90 may control the overall operation of the cleaner 1.

The controller 90 may include at least one processor 91 that controls the operation of the cleaner 1 and at least one memory 92 that stores programs and data for controlling the operation of the cleaner 1.

The at least one processor 91 may control the overall operation of the cleaner 1. Specifically, the at least one processor 91 may be connected to each configuration of the cleaner 1 to control the overall operation of the cleaner 1. For example, the at least one processor 91 may be electrically connected to the memory 92 to control the overall operation of the cleaner 1. The processor 91 may comprise one or a plurality of processors.

The at least one processor 91 may perform the operation of the cleaner 1 according to various embodiments by executing at least one instruction stored in the memory 92.

The at least one memory 92 may store data required for various embodiments. The memory 92 may be implemented in the form of memory embedded in the cleaner 1 or in the form of memory removably attached to the cleaner 1, depending on the purpose of storing the data. For example, data for driving the cleaner 1 may be stored in memory embedded in the cleaner 1, and data for expanding the functionality of the cleaner 1 may be stored in memory removably attached to the cleaner 1. On the other hand, the memory embedded in the cleaner 1 may be implemented as at least one of a volatile memory (e.g., dynamic random access memory (DRAM), static RAM (SRAM), or synchronous SDRAM, etc.), a non-volatile memory (e.g., one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD)). Furthermore, the memory removably attached to the cleaner 1 may be implemented in the form of a memory card (e.g., compact flash (CF), secure digital (SD), micro secure digital (Micro-SD), mini secure digital (Mini-SD), extreme digital (xD), multi-media card (MMC), etc.), an external memory connectable to a USB port (e.g., a USB memory), or the like.

The at least one processor 91 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 91 may control one or any combination of other configurations of the cleaner 1, and may perform operations related to communication or data processing. The at least one processor 91 may execute at least one program or instruction stored in the memory 92. For example, the at least one processor 91 may perform a method according to at least one embodiment of the present disclosure by executing at least one instruction stored in the memory 92.

In an embodiment, the controller 90 may control the pad moving device 110 in response to a predetermined condition. The controller 90 may be configured to control the moving drive source 111. Controlling the pad moving device 110 may include moving the cleaning pad 101 to the first position and the second position.

For example, in the event that the position sensor 71 detects that the cleaning pad 101 is in the third position, the controller 90 may control the pad moving device 110 to move the cleaning pad 101 to the second position. For example, based on the position sensor 71 detecting that the cleaning pad 101 has deviated from the second position, the controller 90 may operate the moving drive source 111. For example, based on the position sensor 71 detecting that the cleaning pad 101 is in the second position, the controller 90 may stop the operation of the moving drive source 111.

In an embodiment, the controller 90 may control the drum drive device 23 and/or the intake motor 42 in response to a predetermined condition.

In an embodiment, the controller 90 may control the driving device 60 in response to a predetermined condition. Controlling the driving device 60 may include moving the cleaner 1.

A cleaner according to an embodiment includes a housing, a cleaning pad movable to a first position and a second position, the cleaning pad spaced farther from a center of the housing in the second position than in the first position, and a pad moving device for moving the cleaning pad. The pad moving device includes a moving drive source configured to generate power, a lever gear configured to receive the power generated by the moving drive source and rotate relative to the moving drive source based on the received power, a guide gear configured to rotate relative to the lever gear based on rotation of the lever gear, a guide lever that is rotatable relative to the guide gear and configured to rotate relative to the lever gear based on rotation of the guide gear, and an elastic member that is elastically deformable and configured to rotate the guide lever relative to the guide gear. The elastic member is configured such that, with an obstacle causing the cleaning pad to move from the second position, the elastic member provides a force to move the cleaning pad toward the second position.

The cleaner may further include a pad rotating device on which the cleaning pad is mounted, the pad rotating device configured to rotate the cleaning pad. The guide lever may be coupled to the pad rotating device.

The pad rotating device may include a first portion to which the guide lever is coupled, the first portion rotatable about a rotation axis of the guide lever based on rotation of the guide lever, and a second portion on which the cleaning pad is mounted, the second portion configured to move based on rotation of the first portion.

A rotation axis of the first portion of the pad rotating device and the rotation axis of the guide lever may be coaxial.

A rotation axis of the first portion of the pad rotating device may be parallel to a rotation axis of the lever gear.

With the cleaning pad in the second position, based on a force applied to the cleaning pad to move the cleaning pad in a direction toward the first position, the guide lever may be configured to rotate to move the cleaning pad to a third position between the first position and the second position.

With the guide lever is rotated to move the cleaning pad to the third position, the elastic member may apply a force to the guide lever in a direction in which the guide lever moves the cleaning pad to the second position.

The elastic member may include a first end fixed to the guide gear, and a second end fixed to the guide lever and opposite to the first end.

The guide gear may include an elastic member receiving portion in which the elastic member is received. The guide lever may include a core support portion that is supported by the elastic member received in the elastic member receiving portion.

The guide lever may include an elastic member receiving portion in which the elastic member is received. The guide gear may include a guide support portion that is supported by the elastic member received in the elastic member receiving portion.

The cleaner may further include a guide cover that covers at least a portion of the pad moving device. The guide cover may include a lever stopper configured to limit a rotation range of the lever gear.

The cleaner may further include a position sensor configured to detect a position of the cleaning pad, and a controller configured to control the moving drive source. The controller may be configured to stop an operation of the moving drive source based on the detected position of the cleaning pad indicating the cleaning pad is in the second position, and operate the moving drive source based on the detected position of the cleaning pad indicating the cleaning pad is moved from the second position.

The lever gear may include lever gear teeth and a gear support portion having a shape different from a shape of the lever gear teeth. With the cleaning pad in the first position and being rotated by a pad rotating device, in order to prevent the cleaning pad from moving to the second position, the lever gear may be rotatable to a support position in which the gear support portion engages the guide gear.

The gear support portion may be larger than a tooth of the lever gear teeth. The guide gear may include a gear receiving portion configured to receive the gear support portion.

The elastic member may include a compression spring or a torsion spring.

The lever gear and the guide gear may be configured to rotate in opposite directions.

A cleaner according to an embodiment includes a housing, a cleaning pad movable to a first position and a second position spaced farther from a center of the housing than the first position, a pad moving device configured to move the cleaning pad, and a pad rotating device configured to mount the cleaning pad thereon is mounted and to rotate the cleaning pad. The pad moving device includes a moving drive source, a lever gear rotatable by power received from the moving drive source, a guide gear rotatable based on rotation of the lever gear, a guide lever rotatable relative to the guide gear and coupled to the pad rotating device, and an elastic member including a first end fixed to the guide gear and a second end fixed to the guide lever.

The pad rotating device may include a first portion to which the guide lever is coupled, the first portion rotatable about a rotation axis of the guide lever based on rotation of the guide lever, and a second portion on which the cleaning pad is mounted, the second portion movable based on rotation of the first portion.

While the cleaning pad is in the second position, based on a force being applied to the cleaning pad in a direction toward the first position, the guide lever may be rotatable to move the cleaning pad to a third position between the first position and the second position.

The guide gear may include an elastic member receiving portion configured to receive the elastic member. The guide lever may include a core support portion configured to be supported by the elastic member received in the elastic member receiving portion.

The cleaner may further include a position sensor configured to detect a position of the cleaning pad, and a controller configured to control the moving drive source. The controller may be configured to stop an operation of the moving drive source based on the position sensor detecting that the cleaning pad is in the second position, and operate the moving drive source based on the position sensor detecting that the cleaning pad has deviated from the second position.

According to the spirit of the present disclosure, the cleaning pad may be moved by the elastic force of the elastic member even if the cleaner collides with an obstacle while the cleaning pad is in the second position, thereby improving the movement performance of the cleaning pad.

According to the spirit of the present disclosure, the cleaner may reduce the movement of the cleaning pad to the second position while the cleaning pad is rotating in the first position, so that the cleaning pad may perform cleaning stably.

The effects to be obtained from the present disclosure are not limited to those mentioned above, and other effects not mentioned will be apparent to a person skilled in the art to which the present disclosure belongs from the following description.

Although specific embodiments have been illustrated and described above, the present disclosure is not limited to the above-described embodiments, and various changes and modifications can be made by those skilled in the art without departing from the gist of the technical spirit of the invention described in the claims below.

1. A cleaner comprising;
a housing;
a cleaning pad movable to a first position and a second position, the cleaning pad spaced farther from a center of the housing in the second position than in the first position; and
a pad moving device configured to move the cleaning pad, the pad moving device including:
a moving drive source configured to generate power,
a lever gear configured to receive the power generated by the moving drive source and rotate relative to the moving drive source based on the received power,
a guide gear configured to rotate relative to the lever gear based on rotation of the lever gear,
a guide lever that is rotatable relative to the guide gear and configured to rotate relative to the lever gear based on rotation of the guide gear, and
an elastic member that is elastically deformable and configured to rotate the guide lever relative to the guide gear,
wherein the elastic member is configured such that, with an obstacle causing the cleaning pad to move from the second position, the elastic member provides a force to move the cleaning pad toward the second position.

2. The cleaner of claim 1, further comprising:
a pad rotating device on which the cleaning pad is mounted, the pad rotating device configured to rotate the cleaning pad,
wherein the guide lever is coupled to the pad rotating device.

3. The cleaner of claim 2, wherein the pad rotating device includes:
a first portion to which the guide lever is coupled, the first portion rotatable about a rotation axis of the guide lever based on rotation of the guide lever, and
a second portion on which the cleaning pad is mounted, the second portion configured to move based on rotation of the first portion.

4. The cleaner of claim 3, wherein a rotation axis of the first portion of the pad rotating device and the rotation axis of the guide lever are coaxial.

5. The cleaner of claim 3, wherein a rotation axis of the first portion of the pad rotating device is parallel to a rotation axis of the lever gear.

6. The cleaner of claim 1, wherein with the cleaning pad in the second position, based on a force applied to the cleaning pad to move the cleaning pad in a direction toward the first position, the guide lever is configured to rotate to move the cleaning pad to a third position between the first position and the second position.

7. The cleaner of claim 6, wherein with the guide lever rotated to move the cleaning pad to the third position, the elastic member applies a force to the guide lever in a direction in which the guide lever moves the cleaning pad to the second position.

8. The cleaner of claim 1, wherein the elastic member includes:
a first end fixed to the guide gear, and
a second end fixed to the guide lever and opposite to the first end.

9. The cleaner of claim 1, wherein
the guide gear includes an elastic member receiving portion in which the elastic member is received, and
the guide lever includes a core support portion that is supported by the elastic member received in the elastic member receiving portion.

10. The cleaner of claim 1, wherein
the guide lever includes an elastic member receiving portion in which the elastic member is received, and
the guide gear includes a guide support portion that is supported by the elastic member received in the elastic member receiving portion.

11. The cleaner of claim 1, further comprising:
a guide cover that covers at least a portion of the pad moving device,
the guide cover includes a lever stopper configured to limit a rotation range of the lever gear.

12. The cleaner of claim 1, further comprising:
a position sensor configured to detect a position of the cleaning pad; and
a controller configured to:
stop an operation of the moving drive source based on the detected position of the cleaning pad indicating the cleaning pad is in the second position, and
operate the moving drive source based on the detected position of the cleaning pad indicating the cleaning pad is moved from the second position.

13. The cleaner of claim 1, wherein
the lever gear includes lever gear teeth and a gear support portion having a shape different from a shape of the lever gear teeth, and
with the cleaning pad in the first position and being rotated by a pad rotating device, in order to prevent the cleaning pad from moving to the second position, the lever gear is rotatable to a support position in which the gear support portion engages the guide gear.

14. The cleaner of claim 13, wherein
the gear support portion is larger than a tooth of the lever gear teeth, and
the guide gear includes a gear receiving portion configured to receive the gear support portion.

15. The cleaner of claim 1, wherein the elastic member includes a compression spring or a torsion spring.

16. The cleaner of claim 1, wherein the lever gear and guide gear are configured to rotate in opposite directions.
